(19) United States
(12) Patent Application Publication
(10) Pub. No.: US 2011/0269018 A1
(43) Pub. Date: Nov. 3, 2011

(54) ELECTRODE FOR ELECTROCHEMICAL DEVICE AND ELECTROCHEMICAL DEVICE USING THE SAME

(76) Inventors: Satoshi Kono, Kyoto (JP); Mitsuhiro Kishimi, Kyoto (JP); Masayuki Oya, Kyoto (JP)

(21) Appl. No.: 13/142,964

(22) PCT Filed: Jun. 17, 2010
(86) PCT No.: PCT/JP2010/060293

§ 371 Date: Jun. 30, 2011

(30) Foreign Application Priority Data
Jun. 17, 2009 (JP) 2009-144132
Sep. 9, 2009 (JP) 2009-207857
Oct. 28, 2009 (JP) 2009-247501

(51) Int. Cl. H01M 4/131; H01M 4/505; H01G 9/00; H01M 4/525; H01M 4/485; H01M 4/62; H01B 1/04

(52) U.S. Cl. 429/217; 429/223; 429/224; 429/231.1; 429/231.6; 252/182.1; 252/509; 252/506; 361/500

(57) ABSTRACT

An electrode for an electrochemical device of the present invention includes an electrode mixture layer that includes a lithium-containing composite oxide expressed by the general composition formula (1): Li₁₊ₓMO₂ as an active material, where x satisfies −0.3≦x≦0.3 and M represents an element group including Ni, Mn, and Mg. The relationships 70≦a≦97, 0.5<b<30, 0.5<c<30, −10<b−c<10, and −8≦(b−c)/c≦8 are established, where a, b, and c represent the ratios of the number of elements of Ni, Mn, and Mg in the element group M to the total number of elements in the element group M, respectively, in units of mol %. The Ni has an average valence of 2.5 to 3.2, the Mn has an average valence of 3.5 to 4.2, and the Mg has an average valence of 1.8 to 2.2.

### TECHNICAL FIELD

The present invention relates to an electrode that can be used for an electrochemical device such as a battery or a capacitor, and an electrochemical device using the electrode.

### BACKGROUND ART

In recent years, small size, lightweight, and high capacity electrochemical devices such as a secondary battery and a capacitor have been required with the development of portable electronic equipment such as a portable telephone and a notebook personal computer or the practical use of electric vehicles. At present, the high capacity secondary battery or capacitor that can meet this requirement generally uses LiCoO₂, LiNiO₂, LiMn₂O₄, or the like as a positive electrode active material.

In particular, LiNiO₂ is the positive electrode active material suitable for the high capacity battery or capacitor. However, the stability of a crystal structure in a state of charge is lower for LiNiO₂ than for LiCoO₂. Therefore, it is difficult to satisfy the safety of the battery or capacitor with LiNiO₂ alone. Moreover, the charge-discharge cycle life of LiNiO₂ is not sufficient due to low reversibility of the crystal structure.

Under these circumstances, in order to maintain the crystal structure of LiNiO₂ in the state of charge, a lithium-containing composite oxide in which a part of Ni is replaced by an element such as Co, Al, or Mg has been proposed and intended for improvement in safety and reversibility (e.g., Patent Document 1).

### PRIOR ART DOCUMENTS

### Patent Documents

Patent Document 1: JP 2007-273108A

### DISCLOSURE OF INVENTION

### Problem to be Solved by the Invention

However, the lithium-containing composite oxide as disclosed in Patent Document 1 has low initial charge-discharge efficiency, and therefore the reduction in capacity is likely to be significant. Moreover, since the true density of the lithium-containing composite oxide is low, when it is provided in an electrode, the capacity cannot be increased easily. Thus, there is still room for further improvement in capacity of the electrochemical device. Furthermore, there is also room for improvement in charge-discharge cycle characteristics of the electrochemical device.

### Means for Solving Problem

With the foregoing in mind, it is an object of the present invention to provide an electrode for an electrochemical device with a high capacity and high stability, and an electrochemical device that includes the electrode for an electrochemical device and has a high capacity, excellent charge-discharge cycle characteristics, and excellent safety.

An electrode for an electrochemical device of the present invention includes an electrode mixture layer that includes a lithium-containing composite oxide expressed by the following general composition formula (1) as an active material:

Li₁₊ₓMO₂ (1)

where x satisfies −0.3×0.3 and M represents an element group including Ni, Mn, and Mg. The relationships 70≦a≦97, 0.5<b<30, 0.5<c<30, −10<b−c<10, and −8≦(b−c)/c≦8 are established, where a, b, and c represent the ratios of the number of elements of Ni, Mn, and Mg in the element group M to the total number of elements in the element group M, respectively, in units of mol %. The Ni has an average valence of 2.5 to 3.2, the Mn has an average valence of 3.5 to 4.2, and the Mg has an average valence of 1.8 to 2.2.

An electrochemical device of the present invention includes a positive electrode, a negative electrode, and a non-aqueous electrolyte. The positive electrode is the electrode for an electrochemical device according to any one of claims 1 to 14.

### Effects of the Invention

The present invention can provide an electrode for an electrochemical device with a high capacity and high stability, and also can provide an electrochemical device that includes the electrode for an electrochemical device and has a high capacity, excellent charge-discharge cycle characteristics, and excellent safety.

### BRIEF DESCRIPTION OF DRAWINGS

FIG. 1A is a schematic plan view of a lithium secondary battery of the present invention. FIG. 1B is a schematic cross-sectional view of FIG. 1A.

FIG. 2 is a schematic diagram of the appearance of a lithium secondary battery of the present invention.

### DESCRIPTION OF THE INVENTION

### Embodiment 1

First, an electrode for an electrochemical device (also simply referred to as “electrode” in the following) of the present invention will be described. The electrode for an electrochemical device of the present invention includes an electrode mixture layer that includes a lithium-containing composite oxide expressed by the general composition formula (1): Li₁₊ₓMO₂ as an active material. In the general composition formula (1), x satisfies −0.3≦x≦0.3 and M represents an element group including Ni, Mn, and Mg. The relationships 70≦a≦97, 0.5<b<30, 0.5<c<30, −10<b−c<10, and −8≦(b−c)/c≦8 are established, where a, b, and c represent the ratios of the number of elements of Ni, Mn, and Mg in the element group M to the total number of elements in the element group M, respectively, in units of mol %. The Ni has an average valence of 2.5 to 3.2, the Mn has an average valence of 3.5 to 4.2, and the Mg has an average valence of 1.8 to 2.2.

The lithium-containing composite oxide acts as a positive electrode active material of an electrochemical device such as a lithium secondary battery. The use of the lithium-containing composite oxide as an active material can provide the electrode for an electrochemical device with a high capacity and high stability.

<Lithium-Containing Composite Oxide>

Hereinafter, the lithium-containing composite oxide used for the electrode of the present invention will be described. The lithium-containing composite oxide used for the electrode of the present invention includes the element group M including at least Ni, Mn, and Mg.

The Ni is a component that contributes to the improvement in capacity of the lithium-containing composite oxide. In the general composition formula (1) of the lithium-containing composite oxide, when the total number of elements in the element group M is 100 mol %, the ratio a (mol %) of the number of elements of Ni is 70 mol % or more so as to improve the capacity of the lithium-containing composite oxide. However, if the ratio of Ni in the element group M is too large, e.g., the amount of Mn or Mg is reduced, and the effects of these elements become smaller. Therefore, the ratio a (mol %) of the number of elements of Ni is 97 mol % or less.

In the present invention, by controlling the ratio of Ni in the element group M in the above range, the capacity of the lithium-containing composite oxide can be 185 mAb/g or more at a drive voltage of 2.5 to 4.3 V on the basis of a lithium metal.

The electric conductivity of the lithium-containing composite oxide decreases with a decrease in the average valence of Ni. For this reason, in the lithium-containing composite oxide, the average valence (A) of Ni is 2.5 to 3.2, which is determined by a method in the example as will be described later. Thus, the lithium-containing composite oxide can achieve a high capacity at a drive voltage of 2.5 to 4.3 V on the bases of a lithium metal.

In the lithium-containing composite oxide, when the total number of elements in the element group M is 100 mol %, the ratio b (mol %) of the number of elements of Mn and the ratio c (mol %) of the number of elements of Mg satisfy 0.5<b<30, 0.5<c<30, −10<b−c<10, and −8≦(b−c)/c≦8. The Mn and the Mg are present in the crystal lattice of the lithium-containing composite oxide. Therefore, when a phase dislocation in the lithium-containing composite oxide occurs due to the elimination and insertion of Li, Mg²⁺ is moved to the Li site, so that an irreversible reaction is relaxed. Accordingly, the reversibility of the layered crystal structure of the lithium-containing composite oxide that is represented by a space group R3-m can be improved. Moreover, since the tetravalent Mn stabilizes the divalent Mg, the electrochemical device can have a long charge-discharge cycle life.

In order to adequately ensure the effect of stabilizing the divalent Mg with the Mn, the ratio b of Mn to all elements in the element group M is preferably 1 mol % or more, and more preferably 2 mol % or more. On the other hand, the ratio b is preferably 10 mol % or less, and more preferably 7 mol % or less. In order to adequately ensure the effect of improving the reversibility of the layered crystal structure of the lithium-containing composite oxide with the Mg, the ratio c of Mg to all elements in the element group M is preferably 1 mol % or more, and more preferably 2 mol % or more. However, since the Mg is less involved in the charged/discharged capacity, the capacity may be reduced if a large amount of Mg is added. Therefore, the ratio c is preferably 15 mol % or less, more preferably 10 mol % or less, and further preferably 7 mol % or less. It is desirable that the difference in composition ratio between the Mn and the Mg is small. Thus, −3≦b−c≦3 is preferred, and also −2≦(b−c)/c≦2 is preferred.

In the lithium-containing composite oxide, the average valence of Mg is 1.8 to 2.2, which is determined by the method in the example as will be described later, so as to improve the reversibility of the crystal structure of the lithium-containing composite oxide. In the lithium-containing composite oxide, the average valence of Mn is 3.5 to 4.2, which is determined by the method in the example as will be described later, so as to make the Mg stable enough to effectively exhibit its function.

The element group M in the general composition formula (1) of the lithium-containing composite oxide includes at least Ni, Mn, and Mg, but also may consist of only these three elements.

Moreover, the element group M may include four or more elements, that is, it may include Co in addition to Ni, Mn, and Mg. When the element group M includes Co, the Co is present in the crystal lattice of the lithium-containing composite oxide. This can further relax the irreversible reaction caused by the phase dislocation in the lithium-containing composite oxide that occurs due to the elimination and insertion of Li during charge and discharge of the electrochemical device. Accordingly, the reversibility of the crystal structure of the lithium-containing composite oxide can be improved. Thus, the electrochemical device can have a long charge-discharge cycle life.

In the case of the element group M including Co, when the total number of elements in the element group M is 100 mol %, the ratio d (mol %) of the number of elements of Co is preferably 0<d<30 so as to prevent the amount of the other elements (Ni, Mn, and Mg) in the element group M from being reduced to make their effects smaller. In order to adequately ensure the effect of improving the reversibility of the crystal structure of the lithium-containing composite oxide with the Co, the ratio d of Co is more preferably 1 mol % or more.

In the lithium-containing composite oxide, the average valence of Co is 2.5 to 3.2, which is determined by the method in the example as will be described later, so as to adequately ensure the above effect of Co.

The element group M in the general composition formula (1) of the lithium-containing composite oxide may include elements other than Ni, Mn, Mg, and Co. For example, the element group M also may include Ti, Cr, Fe, Cu, Zn, Al, Ge, Sn, Ag, Ta, Nb, Mo, B, P, Zr, Ga, Ba, Sr, Ca, Si, W, and S. In order to sufficiently achieve the effects of the present invention, when the total number of elements in the element group M is 100 mol %, the ratio of the elements other than Ni, Mn, Mg, and Co is preferably 15 mol % or less, and more preferably 3 mol % or less. The elements other than Ni, Mn, Mg, and Co in the element group M may be either uniformly distributed in the lithium-containing composite oxide or segregated on the particle surfaces.

Among the above elements, it is preferable that the element group M includes Zr or Ti. The presence of these elements can further improve the charge-discharge cycle characteristics. Both Zr and Ti may be uniformly present in the lithium-containing composite oxide, but more preferably segregated on the surface of the lithium-containing composite oxide. Such a configuration suppresses the surface activity of the lithium-containing composite oxide without impairing its electrochemical properties and allows the lithium-containing composite oxide to serve as an active material that is excellent in charge-discharge cycle characteristics, high-temperature storage characteristics, and thermal stability. Therefore, the surface of the lithium-containing composite oxide may be coated with a Zr or Ti compound such as a Zr oxide or a Ti oxide. Consequently, impurities or by-products on the particle surfaces of the lithium-containing composite oxide can be reduced. Moreover, when an electrode mixture layer is formed using a composition (paste, slurry, etc.) including the lithium-containing composite oxide, it is possible not only to suppress gelation of the composition, but also to improve the coating stability.

In order to prevent a reduction in capacity of the lithium-containing composite oxide, the content of Zr or Ti is preferably 5 mass % or less, and more preferably 1 mass % or less of all particles of the lithium-containing composite oxide including Zr and Ti (if the particle surfaces are coated with the Zr or Ti compound, the particles also include the coatings). On the other hand, the content is preferably 0.001 mass % or more so as to sufficiently achieve the effect of suppressing the surface activity of the lithium-containing composite oxide.

The true density of the lithium-containing composite oxide having the above composition is as high as 4.55 to 4.95 g/cm³. Thus, the capacity of the active material per mass can be increased, and the reversibility also can be improved.

The true density of the lithium-containing composite oxide is high particularly when the composition is close to a stoichiometric ratio. Therefore, in the present invention, x of the general composition formula (1) satisfies −0.3≦x≦0.3. By controlling the value of x in this range, the true density and the reversibility can be improved. It is more preferable that x is −0.1 to 0.1. In such a case, the lithium-containing composite oxide can have a higher true density of 4.6 g/cm³ or more.

If x<0, i.e., if there is a lack of Li compared to the stoichiometric ratio, Ni enters the Li site of the Li layer constituting the layered structure of the lithium-containing composite oxide and is likely to cause a structural distortion while the lithium-containing composite oxide is synthesized. In an X-ray diffraction diagram, assuming that the integrated intensity of a diffraction line in a (003) plane and the integrated intensity of a diffraction line in a (104) plane are represented by I₍₀₀₃₎ and I₍₁₀₄₎, respectively, the ratio of I₍₀₀₃₎ to I₍₀₀₄₎ (integrated intensity ratio: I₍₀₀₃₎/I₍₁₀₄₎) is preferably 1.2 or more for a stable structure. However, if the above structural distortion occurs, the integrated intensity ratio is smaller than 1.2, so that the charged/discharged capacity is reduced and the cycle characteristics are degraded.

Even in the case of x<0, when Mg is dissolved in the crystal to form a solid solution, the Li layer is easily formed and Ni can be prevented from entering the Li layer. Therefore, the integrated intensity ratio I₍₀₀₃₎/I₍₁₀₄₎ can be 1.2 or more, and the reversibility of the crystal structure can be improved. Thus, the lithium-containing composite oxide can achieve both a high capacity and excellent cycle characteristics.

Moreover, the composition is designed to have a smaller Li ratio than the stoichiometric ratio, and therefore the amount of Li added can be reduced in the synthesis of the lithium-containing composite oxide. This can prevent excess compounds such as Li₂CO₃ and LiOH from being produced or left, and thus can suppress degradation in quality of a mixture coating due to the excess compounds, thereby facilitating the preparation and quality control of the coating.

Since the surface activity of the lithium-containing composite oxide is properly suppressed, the electrochemical device using the electrode of the present invention can reduce the gas generation. In particular, when the electrochemical device is a battery having a square (i.e., rectangular cylindrical) outer can, the outer can is not likely to be deformed, so that the storage characteristics and life of the battery can be improved. In order to ensure these effects, it is preferable that the lithium-containing composite oxide has the following aspects.

First, the particles of the lithium-containing composite oxide mainly include secondary particles formed by the agglomeration of primary particles. The ratio of the volume of the primary particles with a particle size of 1 μm or less to the total volume of the primary particles is preferably 30 vol % or less, and more preferably 15 vol % or less. The BET specific surface area of the particles of the lithium-containing composite oxide is preferably 0.3 m²/g or less, and more preferably 0.25 m²/g or less.

In the lithium-containing composite oxide, if the ratio of the primary particles with a particle size of 1 μm or less in all the primary particles is too large, or the BET specific surface area is too large, the reaction area of the lithium-containing composite oxide is increased and the number of active sites becomes larger. Therefore, irreversible reactions are likely to occur between the lithium-containing composite oxide and a) moisture in the air, b) a binder used to form the electrode mixture layer of the electrode that uses the moisture as an active material, and c) a non-aqueous electrolyte of the electrochemical device that includes the electrode. Such irreversible reactions are likely to pose problems of the deformation of the outer can caused by the generation of gas in the electrochemical device and the gelation of the composition (paste, slurry, etc.) including a solvent used to form the electrode mixture layer.

The lithium-containing composite oxide may include no primary particle with a particle size of 1 μm or less. In other words, the ratio of the primary particles with a particle size of 1 μm or less may be 0 vol %. Moreover, the BET specific surface area is preferably 0.1 m²/g or more so as to prevent the reactivity of the lithium-containing composite oxide from being reduced more than necessary. The number average particle size of all particles of the lithium-containing composite oxide, including the primary particles that are not agglomerated and the secondary particles that are formed by the agglomeration of the primary particles, is preferably 5 to 25 μm. This is because if the number average particle size is within the above range, the BET specific surface area can be controlled in the appropriate range.

The ratio of the primary particles with a particle size of 1 μm or less included in the lithium-containing composite oxide, the number average particle size of all particles of the lithium-containing composite oxide, and the number average particle size of other active materials (as will be described later) can be measured by a laser diffraction/scattering particle size distribution analyzer, e.g., “MICROTRAC HRA” manufactured by NIKKISO CO., LTD. The values shown in Examples (as will be described later) were measured by this method. The BET specific surface area of the lithium-containing composite oxide is measured using a BET equation, which is a theoretical equation for multilayer adsorption. Specifically, the BET specific surface area is measured by a surface area analyzer “Macsorb HM model-1201” manufactured by Mountech Co., Ltd. based on a nitrogen adsorption method.

In order to increase the density of the electrode mixture layer of the electrode that uses the lithium-containing composite oxide as an active material and to further improve the capacity of the electrode as well as the capacity of the electrochemical device, it is preferable that the particles of the lithium-containing composite oxide are spherical or substantially spherical in shape. Thus, in a press process during production of the electrode (as will be described in detail later), when the particles of the lithium-containing composite oxide are pressed and moved to increase the density of the electrode mixture layer, the particles are easily moved and smoothly rearranged. Therefore, the press load can be small, which in turn reduces damage to a current collector caused by pressing. Accordingly, the productivity of the electrode can be improved. Moreover, the spherical or substantially spherical particles of the lithium-containing composite oxide can withstand larger pressure in the press process, so that the electrode mixture layer can have a higher density.

In the lithium-containing composite oxide, the tap density is preferably 2.4 g/cm³ or more, and more preferably 2.8 g/cm³ or more so as to improve the filling properties in the electrode mixture layer. If the tap density is high and no hole is formed in a particle or the proportion of holes in a particle is small (e.g., the area ratio of tiny holes of 1 μm or less measured by cross-section observation of the particle is 10% or less), the filling properties of the lithium-containing composite oxide in the electrode mixture layer can be improved.

The tap density of the lithium-containing composite oxide can be determined using a tap density measuring device “POWDER TESTER MODEL PT-S” manufactured by HOSOKAWA MICRON CORPORATION in the following manner. First, the measuring particles are put in a 100 cm³ measuring cup and leveled off. Then, tapping is performed for 180 seconds while adding the particles by the amount corresponding to a decrease in volume as needed. After the tapping is finished, excess particles are leveled off with a blade. Subsequently, the mass T(g) of the measuring particles is measured, and the tap density is determined by the following formula.

Tap density(g/cm³)=T/100

<Method for Producing the Lithium-Containing Composite Oxide>

Next, a method for producing the lithium-containing composite oxide will be described. It is very difficult to obtain a lithium-containing composite oxide of high purity simply by mixing, e.g., a Li-containing compound, a Ni-containing compound, a Mn-containing compound, and a Mg-containing compound and firing the resultant mixture. The reason for this is considered as follows. Since Ni, Mn, Mg, or the like has a slow diffusion velocity in a solid, it is difficult to diffuse these elements uniformly during the synthesis reaction of the lithium-containing composite oxide. Therefore, Ni, Mn, Mg, or the like is not likely to be uniformly distributed in the lithium-containing composite oxide produced.

A preferred method for producing the lithium-containing composite oxide of the present invention includes firing a Li-containing compound and a composite compound containing at least Ni, Mn, and Mg (and further Co, if the element group M also includes Co) as constituent elements. With this method, the lithium-containing composite oxide of high purity can be relatively easily synthesized. The composite compound containing at least Ni, Mn, and Mg (and further Co) is produced beforehand. When the composite compound is fired along with the Li-containing compound, Ni, Mn, and Mg (and further Co) are uniformly distributed during the reaction to form an oxide, thus synthesizing a lithium-containing composite oxide of higher purity.

The method for producing the lithium-containing composite oxide of the present invention is not limited to the above method. However, it is assumed that the physical properties such as structural stability, charge-discharge reversibility, and true density of the lithium-containing composite oxide vary significantly depending on what production process is used.

The composite compound containing at least Ni, Mn, and Mg (and further Co) may be, e.g., a coprecipitation compound containing Ni, Mn, and Mg (and further Co), a hydrothermally synthesized compound, a mechanically synthesized compound, or a compound obtained by the heat treatment of them. Preferred examples of the composite compound include an oxide or a hydroxide of Ni, Mn, and Mg and an oxide or a hydroxide of Ni, Mn, Mg, and Co such as Ni_{0.7}Mn_{0.1}Mg_{0.2}(OH)₂ and Ni_{0.9}C_{0.05}Mn_{0.03}Mg_{0.02}(OH)₂.

The coprecipitation compound can be produced, e.g., by preparing an aqueous solution in which a sulfate or nitrate including constituent elements of Ni, Mn, Mg, Co, etc. is dissolved at a predetermined ratio, adding the aqueous solution to an alkali hydroxide solution, and allowing the aqueous solution and the alkali hydroxide solution to react to form a coprecipitation oxide of the constituent elements.

Ammonia water whose pH is adjusted to about 10 to 13 with an alkali hydroxide may be used instead of the alkali hydroxide solution. Specifically, the temperature of the ammonia water is maintained constant approximately in the range of 40 to 60° C. The aqueous solution in which the sulfate or nitrate is dissolved is gradually added to the ammonia water while adding an alkaline solution so as to maintain the pH of the ammonia water constant in the above range, so that the coprecipitation compound is precipitated. Thus, the constituent elements of the coprecipitation compound are uniformly distributed, and the average valences of Ni, Mn, and Mg (and further Co) of the synthesized lithium-containing composite oxide can be easily controlled in the respective ranges of the present invention.

When the element group M of the lithium-containing composite oxide includes elements other than Ni, Mn, Mg, and Co, e.g., at least one element selected from the group consisting of Ti, Cr, Fe, Cu, Zn, Al, Ge, Sn, Ag, Ta, Nb, Mo, B, P, Zr, Ga, Ba, Sr, Ca, Si, W, and S (these elements are grouped together into “element M′” in the following), such a lithium-containing composite oxide can be produced by mixing the composite compound containing at least Ni, Mn, and Mg (and further Co), the Li-containing compound, and a compound containing the element M′ and firing the resultant mixture. However, if possible, it is preferable to use a composite compound containing not only at least Ni, Mn, and Mg (and further Co), but also the element M′. The quantitative ratios of Ni, Mn, Mg, and M′ or the quantitative ratios of Ni, Mn, Mg, Co, and M′ in the composite compound may be appropriately adjusted in accordance with the composition of the intended lithium-containing composite oxide.

The Li-containing compound that can be used for the production of the lithium-containing composite oxide may be various lithium salts including, e.g., lithium hydroxide monohydrate, lithium nitrate, lithium carbonate, lithium acetate, lithium bromide, lithium chloride, lithium citrate, lithium fluoride, lithium iodide, lithium lactate, lithium oxalate, lithium phosphate, lithium pyruvate, lithium sulfate, and lithium oxide. In particular, the lithium hydroxide monohydrate is preferred because it does not generate gas that has harmful effects on the environment such as a carbonic acid gas, nitrogen oxides, and sulfur oxides.

As described above, in order to produce the lithium-containing composite oxide, first, the composite compound containing at least Ni, Mn, and Mg (and further Co and the element M′), the Li-containing compound, and the compound containing the element M′ used as needed are mixed at the ratio substantially corresponding to the composition of the intended lithium-containing composite oxide. Then, the material mixture thus obtained is fired, e.g., at 600 to 1000° C. for 1 to 24 hours, resulting in the lithium-containing composite oxide.

A lithium-containing composite oxide including Zr or Ti can be produced, e.g., by the following method.

First, an aqueous solution in which a sulfate or nitrate including constituent elements of Ni, Mn, Mg, Co, etc. is dissolved at a predetermined ratio is prepared and added to an alkali hydroxide solution. The aqueous solution and the alkali hydroxide solution react to form a coprecipitation oxide of the constituent elements. Then, the coprecipitation oxide is sufficiently washed with water and dried. Subsequently, a lithium salt and a compound such as ZrO₂ or TiO₂ are added to and sufficiently mixed with the coprecipitation oxide. This mixture is fired at a predetermined temperature and allowed to react so that the lithium-containing composite oxide can be provided.

As described above, ammonia water whose pH is adjusted to about 10 to 13 with an alkali hydroxide may be used instead of the alkali hydroxide solution.

In addition to the above method in which the coprecipitation oxide, the lithium salt, and the Zr or Ti compound are mixed and fired, another method also may be employed. When the Zr or Ti compound is further added to a reaction solution in which the coprecipitation compound has been precipitated, a composite material can be formed by coating the precipitation oxide of the constituent elements with the Zr or Ti compound. This composite material is fired along with the lithium salt, thus providing the lithium-containing composite oxide.

A method for coating the surface of the lithium-containing composite oxide with the Zr or Ti compound may include mixing the lithium-containing composite oxide and the Zr or Ti compound, and firing the mixture at about 100 to 1000° C.

In the firing of the material mixture, it is preferable that the reaction proceeds by raising the temperature gradually rather than immediately to a predetermined temperature. That is, the temperature is first raised to a temperature (e.g., 250 to 850° C.) lower than the firing temperature, this temperature is maintained for preheating, and then the temperature is raised to the firing temperature. Moreover, it is preferable that the oxygen concentration in the firing environment is maintained constant.

The lithium-containing composite oxide of the present invention is likely to have a nonstoichiometric composition in the production process, since the trivalent Ni is unstable. For this reason, the reaction of the composite compound containing at least Ni, Mn, and Mg (and further Co and the element M′), the Li-containing compound, and the compound containing the element M′ used as needed is allowed to proceed step by step, thereby improving the homogeneity of the lithium-containing composite oxide to be produced and achieving stable crystal growth of the lithium-containing composite oxide produced. If the temperature is immediately raised to the firing temperature, or if the oxygen concentration in the firing environment is reduced during firing, it is likely that the reaction of the composite compound containing at least Ni, Mn, and Mg (and further Co and the element M′), the Li-containing compound, and the compound containing the element M′ used as needed becomes nonuniform, and that the uniformity of the composition is impaired, e.g., due to the release of Li from the lithium-containing composite oxide produced.

The preheating time is not particularly limited and generally can be about 0.5 to 30 hours.

The firing environment of the material mixture is an atmosphere of oxygen-containing gas. For example, the atmosphere may be an ambient atmosphere, a mixed gas atmosphere of an inert gas (such as argon, helium, or nitrogen) and an oxygen gas, or an oxygen gas atmosphere. The oxygen concentration (volume basis) in the firing environment is preferably 15% or more, and more preferably 18% or more. In order to maintain the oxygen concentration in the firing environment constant, it is preferable that the material mixture is fired in the atmosphere in which the oxygen-containing gas flows continuously. In order to reduce the production cost of the lithium-containing composite oxide and to improve the productivity of the lithium-containing composite oxide as well as the productivity of the electrode, it is more preferable that the material mixture is fired in the atmospheric flow.

The flow rate of the oxygen-containing gas in the firing of the material mixture is preferably 2 dm³/min or more per 100 g of the material mixture. If the flow rate of the gas is too small, i.e., if the gas flow velocity is too slow, the homogeneity of the composition of the lithium-containing composite oxide may be impaired. Moreover, the flow rate of the gas in the firing of the material mixture is preferably 5 dm³/min or less per 100 g of the material mixture. Thus, the oxygen-containing gas can be used efficiently.

In the firing process of the material mixture, a dry-blended mixture may be used as it is. However, it is preferable that the material mixture is dispersed in a solvent such as ethanol to form a slurry, and the slurry is mixed in a planetary ball mill or the like for about 30 to 60 minutes and dried. This method can further improve the homogeneity of the lithium-containing composite oxide to be produced.

<Electrode Mixture Layer>

Next, the electrode mixture layer used for the electrode of the present invention will be described. The electrode of the present invention includes the electrode mixture layer that includes the lithium-containing composite oxide of the present invention as an active material. However, the electrode mixture layer also may include other active materials. Examples of the active materials other than the lithium-containing composite oxide of the present invention include the following: a lithium cobalt oxide such as LiCoO₂ or LiCO₁₋ₓNiₓO₂; a lithium manganese oxide such as LiMnO₂, Li₂MnO₃, or LiMn₂O₄; a lithium nickel oxide such as LiNiO₂ or LiNi_{1-x-y}CoₓAl_{y}O₂; a lithium-containing composite oxide having a spinel structure such as Li_{4/3} Ti_{5/3}O₄; a lithium-containing composite oxide having an olivine structure such as LiFePO₄; and an oxide having a basic composition of the above oxides in which the constituent elements are replaced by various elements. In particular, by using the active material having a layered structure such as LiCoO₂ that is higher in operating voltage than the lithium-containing composite oxide of the present invention, or the active material having a spinel structure such as LiMn₂O₄ with the lithium-containing composite oxide of the present invention to form a battery, the charge-discharge cycle characteristics can be improved, e.g., with the repetition of charge and discharge cycles in the range in which the depth of discharge is about 10%, that is, with the repetition of charge and use (discharge) cycles in a short time under the actual operating conditions of equipment that incorporates the battery. When the active materials other than the lithium-containing composite oxide of the present invention are used, the ratio (mass ratio) of the other active materials is preferably 1% or more, and more preferably 5% or more of the whole active materials. On the other hand, in order to make the effects of the present invention prominent, the ratio (mass ratio) of the other active materials is preferably 30% or less, and more preferably 20% or less of the whole active materials.

In addition to LiCoO₂, the lithium cobalt oxide of the above active materials is preferably an oxide (except for the lithium-containing composite oxide of the present invention) in which a part of Co of LiCoO₂ is replaced by at least one element selected from the group consisting of Ti, Cr, Fe, Ni, Mn, Cu, Zn, Al, Ge, Sn, Mg, Ga, W, Ba, and Zr. These lithium cobalt oxides have a high conductivity of 1.0×10⁻³S·cm⁻¹ or more and can further improve the load characteristics of the electrode.

In addition to LiMn₂O₄ and Li_{4/3}Ti_{5/3}O₄, the lithium-containing composite oxide having a spinel structure of the above active materials is preferably an oxide in which a part of Mn of LiMn₂O₄ is replaced by at least one element selected from the group consisting of Ti, Cr, Fe, Ni, Co, Cu, Zn, Al, Ge, Sn, Mg, Ga, W, Ba, and Zr. In these lithium-containing composite oxides having a spinel structure, the potential amount of deintercalation of lithium is one-half of that of the lithium-containing composite oxides such as a lithium cobalt oxide and a lithium nickel oxide. Therefore, the lithium-containing composite oxides having a spinel structure have excellent safety in overcharge and can further improve the safety of the electrochemical device.

When the lithium-containing composite oxide of the present invention is used with the other active materials, they may be simply mixed together. However, it is more preferable that their particles are formed into composite particles by granulation or the like. In such a case, the filling density of the active materials in the electrode mixture layer can be improved so as to ensure mutual contact between the active material particles. This can further improve the capacity and load characteristics of the electrochemical device using the electrode of the present invention.

Moreover, the lithium-containing composite oxide and the other active materials may be dry blended and then mixed with a binder or the like to provide a coating material by using a twin-screw kneader, thus forming a mixture layer.

In the case of composite particles of the lithium-containing composite oxide of the present invention and the lithium cobalt oxide, the lithium cobalt oxide is present on the surface of the lithium-containing composite oxide. Therefore, Mn and Co eluted from the composite particles are quickly deposited on the surfaces of the composite particles to form a coating film, so that the composite particles are chemically stabilized. Thus, it is possible to suppress decomposition of the non-aqueous electrolyte in the electrochemical device due to the composite particles, and also to suppress further elution of Mn. Accordingly, the electrochemical device can have more excellent storage characteristics and charge-discharge cycle characteristics.

When the composite particles are used, the number average particle size of one of the lithium-containing composite oxide of the present invention and the other active materials is preferably one-half or less of the number average particle size of the other. In this manner, the particles with a large number average particle size (referred to as “large particles” in the following) and the particles with a small number average particle size (referred to as “small particles” in the following) are combined to form the composite particles. As a result, the small particles are easily dispersed around the large particles and fixed thereto. Thus, the composite particles can be formed with a more uniform mixing ratio. This makes it possible to suppress a nonuniform reaction in the electrode and to further improve the charge-discharge cycle characteristics and safety of the electrochemical device.

As described above, when the large particles and the small particles are used to form the composite particles, the number average particle size of the large particles is preferably 10 to 30 μm and the number average particle size of the small particles is preferably 1 to 15 μm.

The composite particles of the lithium-containing composite oxide of the present invention and the other active materials can be produced in the following manner. For example, the particles of the lithium-containing composite oxide and the particles of the other active materials are mixed using various general kneaders such as a single-screw kneader and a twin-screw kneader, and then the particles are combined by grinding them under shear. In view of the productivity of the composite particles, the particles are preferably mixed by a continuous kneading process that supplies the material continuously.

It is preferable that a binder is further added to the active material particles for kneading. Thus, the shape of the composite particles can be stably maintained. It is more preferable that a conductive assistant is also added for kneading. Thus, the conductivity between the active material particles can be further improved.

Both thermoplastic resin and thermosetting resin may be used as the binder added in the production of the composite particles as long as they are stable in the electrochemical device. Examples of the binder include the following: polyethylene (PE); polypropylene (PP); polytetrafluoroethylene (PTFE); polyvinylidene fluoride (PVDF); polyhexafluoropropylene (PHFP); styrene-butadiene rubber (SBR); tetrafluoroethylene-hexafluoroethylene copolymer; tetrafluoroethylene-hexafluoropropylene copolymer (FEP); tetrafluoroethylene-perfluoroalkylvinyl ether copolymer (PFA); vinylidene fluoride-hexafluoropropylene copolymer; vinylidene fluoride-chlorotrifluoroethylene copolymer; ethylene-tetrafluoroethylene copolymer (ETFE); polychlorotrifluoroethylene (PCTFE); vinylidene fluoride-pentafluoropropylene copolymer; propylene-tetrafluoroethylene copolymer; ethylene-chlorotrifluoroethylene copolymer (ECTFE); vinylidene fluoride-hexafluoropropylene-tetrafluoroethylene copolymer; and vinylidene fluoride-perfluoromethyl vinyl ether-tetrafluoroethylene copolymer, or ethylene-acrylic acid copolymer; ethylene-methacrylic acid copolymer; ethylene-methyl acrylate copolymer; ethylene-methyl methacrylate copolymer; and a Na ion crosslinked body of these copolymers. The above examples of the binder may be used individually or in combinations of two or more. Among the above materials, PVDF, PTFE, and PHFP are preferred in view of the stability in the electrochemical device or the characteristics of the electrochemical device.

The amount of the binder added in the production of the composite particles should be as small as possible if the composite particles can be stabilized, and is preferably, e.g., 0.03 to 2 parts by mass with respect to 100 parts by mass of the whole active materials.

The conductive assistant added in the production of the composite particles is not particularly limited as long as it is chemically stable in the electrochemical device. Examples of the conductive assistant include the following: graphite such as natural graphite or artificial graphite; carbon black such as acetylene black, Ketjen Black (trade name), channel black, furnace black, lamp black, or thermal black; conductive fiber such as carbon fiber or metal fiber; metal powder such as aluminum powder; fluorocarbon; zinc oxide; conductive whisker made of potassium titanate or the like; conductive metal oxide such as titanium oxide; and organic conductive material such as polyphenylene derivative. The above examples of the conductive assistant may be used individually or in combinations of two or more. Among the above materials, the graphite with high conductivity and the carbon black with excellent liquid absorbency are preferred. The conductive assistant is not limited to the form of primary particles and can be in the form of an aggregate such as a secondary aggregate or a chain structure. The conductive assistant in the form of an aggregate is easy to handle and can improve the productivity.

The amount of the conductive assistant added in the production of the composite particles is not particularly limited as long as good conductivity and good liquid absorbency can be ensured, and is preferably, e.g., 0.1 to 2 parts by mass with respect to 100 parts by mass of the whole active materials.

The porosity of the composite particles is preferably 5 to 15%. When the composite particles have such a porosity, the non-aqueous electrolyte (non-aqueous electrolytic solution) can properly come into contact with or permeate through the composite particles.

Like the lithium-containing composite oxide of the present invention, the composite particles are preferably spherical or substantially spherical in shape. Thus, the electrode mixture layer can have a higher density.

<Method for Producing Electrode for Electrochemical Device>

Next, a method for producing an electrode of the present invention will be described. The electrode of the present invention can be produced, e.g. by forming an electrode mixture layer that includes the lithium-containing composite oxide and the composite particles on one side or both sides of a current collector.

The electrode mixture layer can be formed in the following manner. For example, the lithium-containing composite oxide or the composite particles, the binder, and the conductive assistant are added to a solvent to prepare a composition containing the electrode mixture in the form of a paste or slurry. This composition is applied to the surface of the current collector by various coating methods, dried, and then subjected to the press process so as to adjust the thickness and density of the electrode mixture layer.

The method for coating the surface of the current collector with the composition containing the electrode mixture may be, e.g., a substrate lifting method using a doctor blade, a coater method using a die coater, a comma coater, or a knife coater, or a printing method such as screen printing or relief printing.

The binder and the conductive assistant that can be used for the preparation of the composition containing the electrode mixture may be the same as various binders and various conductive assistants that can be used for the formation of the composite particles.

It is preferable that the electrode mixture layer includes 80 to 99 mass % of the active materials including the lithium-containing composite oxide, 0.5 to 10 mass % of the binder (including the binder contained in the composite particles), and 0.5 to 10 mass % of the conductive assistant (including the conductive assistant contained in the composite particles).

The thickness of the electrode mixture layer formed on one side of the current collector is preferably 15 to 200 μm after pressing. Moreover, the density of the electrode mixture layer is preferably 3.1 g/cm³ or more, and more preferably 3.52 g/cm³ or more after pressing. The electrode including the electrode mixture layer of high density can achieve a higher capacity. However, if the density of the electrode mixture layer is too large, the porosity is reduced, and thus may lead to low permeability for the non-aqueous electrolyte. Therefore, the density of the electrode mixture layer is preferably 4.0 g/cm³ or less after pressing. In the press process, e.g., roll pressing can be performed with a linear pressure of about 1 to 100 kN/cm, thereby providing the electrode mixture layer having the above density.

The density of the electrode mixture layer in the context of the present specification is a value measured by the following manner. First, the electrode is cut into a sample having a predetermined area, and the mass of the sample is measured by an electronic force balance with a minimum scale of 0.1 mg. Then, the mass of the current collector is subtracted from the mass of the sample, yielding the mass of the electrode mixture layer. On the other hand, the total thickness of the electrode was measured at 10 points by a micrometer with a minimum scale of 1 μm, and the volume of the electrode mixture layer is calculated from the area and the average of the values obtained by subtracting the thickness of the current collector from the measured values. The density of the electrode mixture layer is determined by dividing the mass by the volume of the electrode mixture layer.

The material for the current collector of the electrode is not particularly limited as long as it is an electronic conductor that is chemically stable in the electrochemical device configured. Examples of the material include the following: aluminum or aluminum alloy; stainless steel; nickel; titanium; carbon; a conductive resin; and a composite material obtained by forming a carbon layer or a titanium layer on the surface of aluminum, aluminum alloy, or stainless steel. Among the above materials, the aluminum or aluminum alloy is particularly preferred because they are lightweight and have high electronic conductivity. The current collector may be, e.g., a foil, a film, a sheet, a net, a punching sheet, a lath, a porous body, a foam body, or a compact of a fibrous material, which are made of the above materials. Moreover, the current collector may be subjected to a surface treatment to make the surface uneven. The thickness of the current collector is not particularly limited and generally can be 1 to 500 μm.

The electrode of the present invention is not limited to that produced by the above method, but may be produced by other methods. For example, when the composite particles are used as active materials, the composite particles may be directly fixed to the surface of the current collector to form the electrode mixture layer, instead of the composition containing the electrode mixture.

In the electrode of the present invention, if necessary, a lead may be formed by a conventional method so as to make an electric connection to the other members in the electrochemical device.

### Embodiment 2

Next, an electrochemical device of the present invention will be described. The electrochemical device of the present invention includes the electrode for an electrochemical device in Embodiment 1 as a positive electrode, a negative electrode, a separator, and a non-aqueous electrolyte.

The electrochemical device of the present invention includes the electrode for an electrochemical device in Embodiment 1 as a positive electrode, and thus can have a high capacity, excellent charge-discharge characteristics, and excellent safety.

The electrochemical device of the present invention is not particularly limited and can be a lithium primary battery or a super capacitor in addition to a lithium secondary battery using a non-aqueous electrolyte. The following is an explanation of the configuration of a lithium secondary battery that is particularly the major use of the electrochemical device.

The negative electrode may have a structure in which a negative electrode mixture layer is formed on one side or both sides of a current collector. The negative electrode mixture layer includes a negative electrode mixture including a negative electrode active material and a binder, and further a conductive assistant as needed.

Examples of the negative electrode active material include the following: one type of carbon materials capable of intercalating and deintercalating an Li ion such as graphite, pyrolytic carbon, coke, glassy carbon, a calcined organic polymer compound, mesocarbon microbeads (MCMB), and a carbon fiber or a mixture of two or more types of the carbon materials. Moreover, examples of the negative electrode active material also include the following: elements such as Si, Sn, Ge, Bi, Sb, and In and their alloys; a lithium-containing nitride; compounds that can be charged/discharged at a low voltage close to lithium metal such as an oxide of Li₄Ti₅O₁₂; a lithium metal; and a lithium/aluminum alloy.

The negative electrode may be produced in such a manner that the negative electrode mixture is obtained by appropriately adding the conductive assistant or the binder as needed to the negative electrode active material, and then formed into a compact (negative electrode mixture layer) while the current collector is used as a core material. Alternatively, foils of the lithium metal or various alloys as described above can be used individually or in the form of a laminate with the current collector.

The binder and the conductive assistant may be the same as various binders and various conductive assistants in Embodiment 1.

The material for the negative electrode current collector is not particularly limited as long as it is an electronic conductor that is chemically stable in the battery configured. Examples of the material include the following: copper or copper alloy; stainless steel; nickel; titanium; carbon; a conductive resin; and a composite material obtained by forming a carbon layer or a titanium layer on the surface of copper, copper alloy, or stainless steel. Among the above materials, the copper or copper alloy is particularly preferred because they are not alloyed with lithium and have high electronic conductivity. The negative electrode current collector may be, e.g., a foil, a film, a sheet, a net, a punching sheet, a lath, a porous body, a foam body, or a compact of a fibrous material, which are made of the above materials. Moreover, the negative electrode current collector may be subjected to a surface treatment to make the surface uneven. The thickness of the negative electrode current collector is not particularly limited and generally can be 1 to 500 μm.

The negative electrode can be produced in the following manner. For example, the negative electrode mixture including the negative electrode active material and the binder, and further the conductive assistant as needed, is dispersed in a solvent to prepare a composition containing the negative electrode mixture in the form of a paste or slurry. This composition is applied to one side or both sides of the negative electrode current collector and then dried, so that the negative electrode mixture layer is formed. The binder may be dissolved in the solvent. The negative electrode is not limited to that produced by the above method, but may be produced by other methods. The thickness of the negative electrode mixture layer formed on one side of the negative electrode current collector is preferably 10 to 300 μm.

The separator is preferably a porous film made of, e.g., polyolefin such as polyethylene, polypropylene, or ethylene-propylene copolymer; or polyester such as polyethylene terephthalate or copolymerized polyester. It is preferable that the separator has the property of being able to close its pores, i.e., shutdown function at 100 to 140° C. For this purpose, the material for the separator is preferably a thermoplastic resin with a melting point of 100 to 140° C. In this case, the melting point is a melting temperature that is measured with a differential scanning calorimeter (DSC) according to the regulations of the Japanese Industrial Standards (JIS) K 7121. For example, a single-layer porous film that includes polyethylene as the main component or a laminated porous film that has 2 to 5 layers of polyethylene and polypropylene can be used as the separator. When the resin with a melting point of 100 to 140° C. such as polyethylene is mixed or laminated with the resin with a higher melting point than polyethylene such as polypropylene, polyethylene is preferably 30 mass % or more, and more preferably 50 mass % or more of the resin constituting the porous film.

The resin porous film may be, e.g., a porous film including the above thermoplastic resin that is used in the conventionally known lithium secondary batteries or the like, i.e., an ion-permeable porous film produced by solvent extraction, dry or wet drawing, or the like.

The average pore diameter of the separator is in the range of preferably 0.01 μm, more preferably 0.05 μm to preferably 1 μm, more preferably 0.5 μm.

The air permeability of the separator is preferably a Gurley value of 10 to 500 sec. The Gurley value is obtained by a method according to JMS P 8117 and expressed as the length of time (seconds) it takes for 100 mL air to pass through a membrane at a pressure of 0.879 g/mm². If the air permeability is too large, the ion permeability can be reduced. On the other hand, if the air permeability is too small, the strength of the separator can be reduced.

It is preferable that the strength of the separator is penetrating strength measured using a 1 mm diameter needle, and that the penetrating strength is 50 g or more. If the penetrating strength of the separator is too small, lithium dendrite crystals may penetrate the separator when they are produced, thus leading to a short circuit.

Since the lithium-containing composite oxide of the present invention has excellent thermal stability, the lithium secondary battery of the present invention can maintain the safety even if the internal temperature of the battery is 150° C. or more.

The non-aqueous electrolyte may be a solution (non-aqueous electrolytic solution) in which an electrolytic salt is dissolved in a solvent. Examples of the solvent include aprotic organic solvents such as propylene carbonate (PC), ethylene carbonate (EC), butylene carbonate (BC), dimethyl carbonate (DMC), diethyl carbonate (DEC), methyl ethyl carbonate (MEC), γ-butyrolactone, 1,2-dimethoxyethane, tetrahydrofuran, 2-methyltetrahydrofuran, dimethyl sulfoxide, 1,3-dioxolane, formamide, dimethylformamide, dioxolane, acetonitrile, nitromethane, methyl formate, methyl acetate, phosphoric trimester, trimethoxymethane, dioxolane derivative, sulfolane, 3-methyl-2-oxazolidinone, propylene carbonate derivative, tetrahydrofuran derivative, diethyl ether, and 1,3-propane sultone. The above examples of the solvent may be used individually or in combinations of two or more. Also, an amineimide organic solvent or a sulfur- or fluorine-containing organic solvent can be used. In particular, a mixed solvent of EC, MEC, and DEC is preferred. It is more preferable that the amount of DEC is 15 vol % to 80 vol % of the total volume of the mixed solvent. Such a mixed solvent allows the low-temperature characteristics and charge-discharge cycle characteristics of the battery to remain high and also improves the stability of the solvent during high voltage charge.

Preferred examples of the electrolytic salt in the non-aqueous electrolyte include lithium perchlorate, organoboron lithium salt, salt of fluorine-containing compound such as trifluoromethanesulfonate, and imide salt. Specifically, the electrolytic salt may be, e.g., LiClO₄, LiPF₆, LiBF₄, LiAsF₆, LiSbF₆, LiCF₃SO₃, LiC₄F₉SO₃, LiCF₃CO₂, Li₂C₂F₄(SO₃)₂, LiN(CF₃SO₂)₂, LiC(CF₃SO₂)₃, LiCnF₂ₙ₊₁SO₃ (2≦n≦5), LiN(Rf₃OSO₂)₂ (where Rf represents a fluoroalkyl group), or LiB(C₂O₄)₂ (lithium bis(oxalate)borate (LiBOB)). The above examples of the electrolytic salt may be used individually or in combinations of two or more. In particular, LiPF₆ and LiBF₄ are more preferred because of good charge-discharge characteristics. The concentration of the electrolytic salt in the solvent is not particularly limited and generally can be 0.5 to 1.7 mol/L.

In order to improve the safety, the charge-discharge cycle characteristics, the high-temperature storage characteristics, or the like, additives such as vinylene carbonates, 1,3-propane sultone, diphenyl disulfide, cyclohexylbenzene, biphenyl, fluorobenzene, and t-butylbenzene can be appropriately added. The additive including a sulfur element is particularly preferred because the surface activity of the active material including Mn can be stabilized.

In the lithium secondary battery of this embodiment, e.g., a stacked electrode is formed by stacking the electrode (positive electrode) of the present invention and the negative electrode via the separator, or a wound electrode is formed by winding the stacked electrode, and then the electrode body, together with the non-aqueous electrolyte, is sealed in the outer package by a conventional method. Like the conventionally known lithium secondary battery, the battery may be in the form of a cylindrical battery using a circular or rectangular cylindrical outer can, a flat-shaped battery using a flat-shaped outer can (that is circular or rectangular when shown in a plan view), or a soft package battery using a metal-deposited laminated film as an outer package. The outer can is made of, e.g., steel or aluminum.

### EXAMPLES

Hereinafter, the present invention will be described in detail by way of examples. However, the present invention is not limited to the following examples.

### Example 1

### Synthesis of the Lithium-Containing Composite Oxide

Ammonia water whose pH has been adjusted to about 12 by the addition of a sodium hydroxide is placed in a reaction vessel. While the ammonia water is strongly stirred, a mixed aqueous solution including a nickel sulfate, a manganese sulfate, and a magnesium sulfate in their respective concentrations of 3.95 mol/dm³, 0.13 mol/dm³, and 0.13 mol/dm³ and a 25 mass % ammonia water are dropped in the reactor using a metering pump at 23 cm³/min and 6.6 cm³/min, respectively. Thus, a coprecipitation compound (spherical coprecipitation compound) of Ni, Mn, and Mg is synthesized. In this case, the temperature of the reaction liquid is maintained at 50° C., and a sodium hydroxide solution in a concentration of 6.4 mol/dm³ is simultaneously dropped so as to maintain the pH of the reaction liquid at around 12. Moreover, the reaction liquid is bubbled with a nitrogen gas at a flow rate of 1 dm³/min.

The coprecipitation compound is washed with water, filtered, and dried, thereby providing a hydroxide containing Ni, Mn, and Mg at a molar ratio of 94:3:3. Then, 0.196 mol of the hydroxide and 0.204 mol of LiOH.H₂O are dispersed in ethanol to form a slurry. The slurry is mixed in a planetary ball mill for 40 minutes and dried at room temperature, so that a mixture is obtained. Next, the mixture is put in an alumina crucible, heated to a temperature of 600° C. in a dry air flow of 2 dm³/min, and held at that temperature for 2 hours for preheating. Further, the temperature is raised to 700° C., and the mixture is fired for 12 hours in an oxygen atmosphere, thus synthesizing a lithium-containing composite oxide. The lithium-containing composite oxide is then pulverized into a powder in a mortar. Subsequently, the powder is stored in a desiccator.

The composition of the powder of the lithium-containing composite oxide is measured with an atomic absorption spectrometer and found to be Li_{1.02}Ni_{0.94}Mn_{0.03}Mg_{0.03}O₂.

In order to perform state analysis of the lithium-containing composite oxide, X-ray absorption spectroscopy (XAS) was conducted using a BL4 beam port of a compact superconducting radiation source “AURORA” (manufactured by Sumitomo Electric Industries Ltd.) in the SR center of the Ritsumeikan University. The resultant data was analyzed with analysis software “REX” (manufactured by Rigaku Corporation) based on Journal of the Electrochemical Society, 146, p. 2799-2809 (1999).

First, the position of the K-absorption edge of each of Ni, Mn, and Mg in the lithium-containing composite oxide was obtained based on the above state analysis.

In order to determine the average valence of Ni in the lithium-containing composite oxide, the state analysis similar to that of the lithium-containing composite oxide was performed using NiO and LiNi_{0.5} Mn_{1.5}O₄ (which are reference samples of the compound containing Ni with an average valence of 2) and LiNi_{0.82} Cu_{0.15}Al_{0.03}O₂ (which is a reference sample of the compound containing Ni with an average valence of 3) as reference samples. Then, a regression line that represents the relationship between the position of the K-absorption edge of Ni and the valence of Ni was created for each of the reference samples. The average valence of Ni obtained from the position of the K-absorption edge of Ni in the lithium-containing composite oxide and the regression line was 3.02.

In order to determine the average valence of Mn in the lithium-containing composite oxide, the state analysis similar to that of the lithium-containing composite oxide was performed using MnO₂, Li₂MnO₃, and LiNi_{0.5}Mn_{1.5}O₄ (which are reference samples of the compound containing Mn with an average valence of 4), LiMn₂O₄ (which is a reference sample of the compound containing Mn with an average valence of 3.5), LiMnO₂ and Mn₂O₃ (which are reference samples of the compound containing Mn with an average valence of 3), and MnO (which is a reference sample of the compound containing Mn with an average valence of 2) as reference samples. Then, a regression line that represents the relationship between the position of the K-absorption edge of Mn and the valence of Mn was created for each of the reference samples. The average valence of Mn obtained from the position of the K-absorption edge of Mn in the lithium-containing composite oxide and the regression line was 4.02.

In order to determine the average valence of Mg in the lithium-containing composite oxide, the state analysis similar to that of the lithium-containing composite oxide was performed using MgO and MgAl₂O₄ (which are reference samples of the compound containing Mg with a average valence of 2) and Mg (which is a reference sample of Mg with an average valence of 0) as reference samples. Then, a regression line that represents the relationship between the position of the K-absorption edge of Mg and the valence of Mg was created for each of the reference samples. The average valence of Mg obtained from the position of the K-absorption edge of Mg in the lithium-containing composite oxide and the regression line was 2.01.

The lithium-containing composite oxide had a BET specific surface area of 0.24 m²/g and a tap density of 2.75 g/cm³. According to the regulations of the Japanese Industrial Standards (JIS) R 1622 “Sample Preparation General Rules for Measuring Particle Size Distribution of Fine Ceramics Materials”, the lithium-containing composite oxide powder was pulverized into primary particles, and the particle size distribution was measured by the laser diffraction/scattering particle size distribution analyzer “MICROTRAC HRA” manufactured by NIKKISO CO., LTD. The results showed that the ratio of the primary particles with a particle size of 1 μm or less to the total volume of the primary particles was 10 vol %. In the measurement, the number of times of pulverization was 20 so as reduce an error.

Moreover, X-ray diffraction of the lithium-containing composite oxide was measured. Specifically, the X-ray diffraction was measured with CuK alpha-ray using an X-ray diffractometer “RINT-2500V/PC” (manufactured by Rigaku Corporation). The resultant data was analyzed with analysis software “JADE” (manufactured by Rigaku Corporation). In the X-ray diffraction diagram, assuming that the integrated intensity of a diffraction line in a (003) plane and the integrated intensity of a diffraction line in a (104) plane were represented by I₍₀₀₃₎ and I₍₁₀₄₎, respectively, the I₍₀₀₃₎ and the I₍₁₀₄₎ were determined from the peak areas of their respective diffraction lines, and the ratio I₍₀₀₃₎/I₍₁₀₄₎ was calculated.

<Production of Positive Electrode>

100 parts by mass of the lithium-containing composite oxide, 20 parts by mass of a N-methyl-2-pyrrolidone (NMP) solution containing PVDF (binder) in a concentration of 10 mass %, 1 part by mass of artificial graphite (conductive assistant), and 1 part by mass of Ketjen Black (conductive assistant) were kneaded using a twin-screw kneader, and then NMP was further added to adjust the viscosity, so that a paste containing the positive electrode mixture was prepared.

This paste containing the positive electrode mixture was applied to both surfaces of an aluminum foil (positive electrode current collector) with a thickness of 15 μm, which then was dried in a vacuum at 120° C. for 12 hours, thereby forming positive electrode mixture layers on both surfaces of the aluminum foil. Subsequently, the press process was performed so as to adjust the thickness and density of the positive electrode mixture layers. Moreover, a lead made of nickel was welded to the exposed portion of the aluminum foil. Thus, a band-shaped positive electrode with a length of 375 mm and a width of 43 mm was produced. Each of the positive electrode mixture layers of the positive electrode produced had a thickness of 55 μm and a density of 3.5 g/cm³.

<Production of Negative Electrode>

97.5 parts by mass of natural graphite (negative electrode active material) with a number average particle size of 10 μm, 1.5 parts by mass of styrene-butadiene-rubber (binder), and 1 part by mass of carboxymethyl cellulose (thickening agent) were mixed with water, so that a paste containing the negative electrode mixture was prepared.

This paste containing the negative electrode mixture was applied to both surfaces of a copper foil (negative electrode current collector) with a thickness of 8 μm, which then was dried in a vacuum at 120° C. for 12 hours, thereby forming negative electrode mixture layers on both surfaces of the copper foil. Subsequently, the press process was performed so as to adjust the thickness and density of the negative electrode mixture layers. Moreover, a lead made of nickel was welded to the exposed portion of the copper foil. Thus, a band-shaped negative electrode with a length of 380 mm and a width of 44 mm was produced. Each of the negative electrode mixture layers of the negative electrode produced had a thickness of 65 μm.

<Production of Non-Aqueous Electrolyte>

A non-aqueous electrolyte was produced by dissolving LiPF₆ at a concentration of 1 mol/L in a mixed solvent containing EC, MEC, and DEC at a volume ratio of 2:3:1.

<Assembly of Battery>

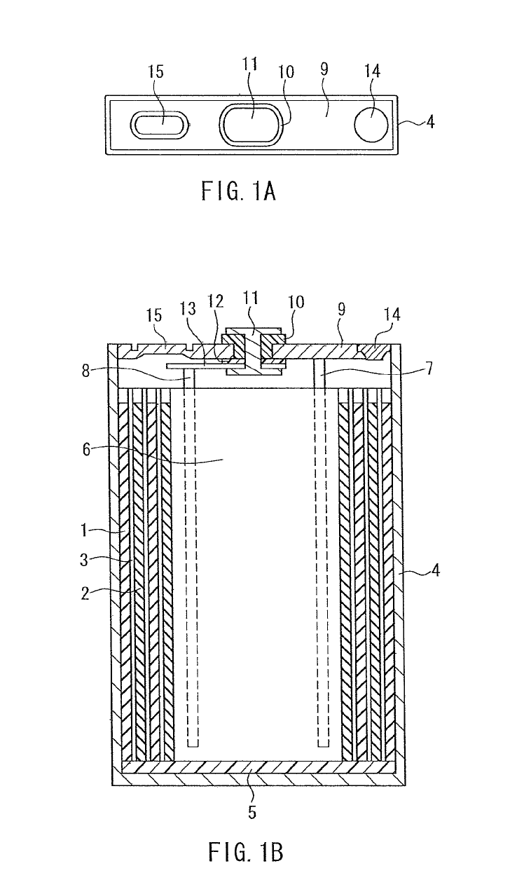

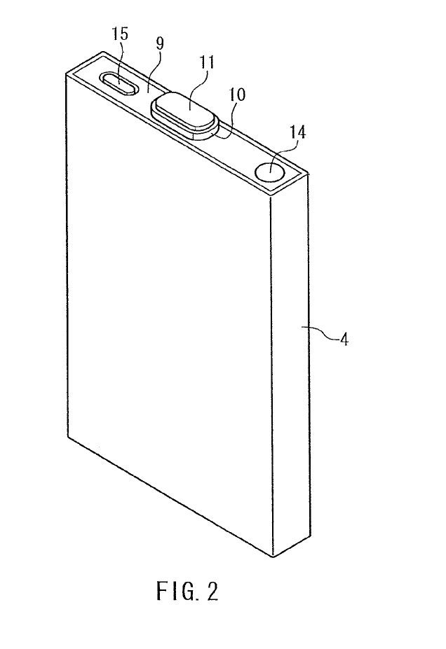

The band-shaped positive electrode was stacked on the band-shaped negative electrode via a microporous polyethylene separator (porosity: 41%) with a thickness of 16 μm, which then was wound in a spiral fashion and pressed into a flat shape, thereby providing a flat-shaped wound electrode body. The wound electrode body was fixed with a polypropylene insulating tape. Next, the wound electrode body was placed in a rectangular battery case that was made of aluminum alloy and had a thickness of 4.0 mm, a width of 34 mm, and a height of 50 mm. Then, a lead was welded, and a cover made of aluminum alloy was welded to the edge of the opening of the battery case. Subsequently, the non-aqueous electrolyte was injected through the inlet of the cover and allowed to stand for 1 hour. Thereafter, the inlet was sealed, and a lithium secondary battery having the structure shown in FIGS. 1A and 1B and the appearance shown in FIG. 2 was produced. The design electric capacity of the lithium secondary battery was 900 mAh.

Hereinafter, the battery as shown in FIGS. 1A, 1B, and 2 will be described. FIG. 1A is a schematic plan view of the lithium secondary battery, and FIG. 1B is a schematic cross-sectional view of FIG. 1A. As shown in FIG. 1B, a positive electrode 1 and a negative electrode 2 are wound via a separator 3 in a spiral fashion, and then pressed into a flat shape, thereby providing a flat-shaped wound electrode body 6. The wound electrode body 6, together with an electrolyte, is housed in a rectangular cylindrical battery case 4. For the sake of simplicity, FIG. 1B does not illustrate a metal foil that is a current collector used for the production of the positive electrode 1 and the negative electrode 2, a non-aqueous electrolyte, or the like.

The battery case 4 is made of aluminum alloy, serves as an outer package of the battery, and is also used as a positive terminal. An insulator 5 made of a polyethylene sheet is placed at the bottom of the battery case 4. A positive electrode lead 7 and a negative electrode lead 8 connected to the respective ends of the positive electrode 1 and the negative electrode 2 are drawn from the flat-shaped wound electrode body 6 including the positive electrode 1, the negative electrode 2, and the separator 3. A stainless steel terminal 11 is attached to a cover 9 via a polypropylene insulating packing 10. The cover 9 is made of an aluminum alloy and used to seal the opening of the battery case 4. A stainless steel lead plate 13 is connected to the terminal 11 via an insulator 12.

The cover 9 is inserted in the opening of the battery case 4, and the joint between them is welded to seal the opening, so that the inside of the battery is hermetically sealed. Moreover, in the battery shown in FIGS. 1A and 113B, the cover 9 has an inlet 14 through which the non-aqueous electrolyte is injected. The inlet 14 is sealed with a sealing member by laser welding or the like. Thus, the sealing properties of the battery are ensured. In the battery shown in FIGS. 1A, 1B, and 2, although the inlet 14 is actually composed of the inlet and the sealing member, they are represented by the inlet 14 for ease of illustration. The cover 9 has a cleavable vent 15 as a mechanism for discharging the gas contained in the battery to the outside when the temperature of the battery is raised.

In the battery of Example 1, the positive electrode lead 7 is directly welded to the cover 9, so that the battery case 4 and the cover 9 can function as a positive terminal. Moreover, the negative electrode lead 8 is welded to the lead plate 13, and thus electrically connected to the terminal 11 via the lead plate 13, so that the terminal 11 can function as a negative terminal.

FIG. 2 is a schematic diagram of the appearance of the battery shown in FIG. 1A. FIG. 2 is intended to illustrate that the battery is in the form of a rectangular battery and only shows particular components of the battery. FIG. 1B does not show the cross section of the inside of the electrode body.

### Example 2

A coprecipitation compound was synthesized in the same manner as Example 1 except for the use of a mixed aqueous solution containing a nickel sulfate, a manganese sulfate, and a magnesium sulfate in their respective concentrations of 3.87 mol/dm³, 0.21 mol/dm³, and 0.13 mol/dm³. Then, a hydroxide containing Ni, Mn, and Mg at a molar ratio of 92:5:3 was obtained in the same manner as Example 1 except for the use of the coprecipitation compound. A lithium-containing composite oxide was synthesized in the same manner as Example 1 except that 0.196 mol of the hydroxide and 0.204 mol of LiOH.H₂O were used. This lithium-containing composite oxide had a BET specific surface area of 0.24 m²/g and a tap density of 2.7 g/cm³. In the lithium-containing composite oxide powder, the ratio of the primary particles with a particle size of 1 μm or less to the total volume of the primary particles, which was measured in the same manner as Example 1, was 12 vol %.

Moreover, a positive electrode and a lithium secondary battery were produced in the same manner as Example 1 except for the use of the above lithium-containing composite oxide. The density of a positive electrode mixture layer of the positive electrode used in the lithium secondary battery was 3.45 g/cm³.

### Example 3

A coprecipitation compound was synthesized in the same manner as Example 1 except for the use of a mixed aqueous solution containing a nickel sulfate, a manganese sulfate, a magnesium sulfate, and aluminum sulfate in their respective concentrations of 3.96 mol/dm³, 0.12 mol/dm³, 0.08 mol/dm³, and 0.04 mol/dm³. Then, a hydroxide containing Ni, Mn, Mg, and Al at a molar ratio of 94:3:2:1 was obtained in the same manner as Example 1 except for the use of the coprecipitation compound. A lithium-containing composite oxide was synthesized in the same manner as Example 1 except that 0.196 mol of the hydroxide and 0.204 mol of LiOH.H₂O were used. This lithium-containing composite oxide had a BET specific surface area of 0.22 m²/g and a tap density of 2.82 g/cm³. In the lithium-containing composite oxide powder, the ratio of the particles with a particle size of 1 μm or less to the total volume of the primary particles, which was measured in the same manner as Example 1, was 8 vol %.

Moreover, a positive electrode and a lithium secondary battery were produced in the same manner as Example 1 except for the use of the above lithium-containing composite oxide. The density of a positive electrode mixture layer of the positive electrode used in the lithium secondary battery was 3.50 g/cm³.

### Example 4

A coprecipitation compound was synthesized in the same manner as Example 1 except for the use of a mixed aqueous solution containing a nickel sulfate, a cobalt sulfate, a manganese sulfate, and a magnesium sulfate in their respective concentrations of 3.87 mol/dm³, 0.25 mol/dm³, 0.04 mol/dm³, and 0.04 mol/dm³. Then, a hydroxide containing Ni, Co, Mn, and Mg at a molar ratio of 92:6:1:1 was obtained in the same manner as Example 1 except for the use of the coprecipitation compound. A lithium-containing composite oxide was synthesized in the same manner as Example 1 except that 0.196 mol of the hydroxide and 0.204 mol of LiOH.H₂O were used. This lithium-containing composite oxide had a BET specific surface area of 0.18 m²/g and a tap density of 2.84 g/cm³. In the lithium-containing composite oxide powder, the ratio of the particles with a particle size of 1 μm or less to the total volume of the primary particles, which was measured in the same manner as Example 1, was 7 vol %.

Moreover, a positive electrode and a lithium secondary battery were produced in the same manner as Example 1 except for the use of the above lithium-containing composite oxide. The density of a positive electrode mixture layer of the positive electrode used in the lithium secondary battery was 3.55 g/cm³.

### Example 5

A hydroxide containing Ni, Co, Mn, and Mg at a molar ratio of 90:5:3:2 was synthesized in the same manner as Example 4 except that the concentrations of the material compounds in the mixed aqueous solution used for synthesis of the coprecipitation compound were changed. A lithium-containing composite oxide was synthesized in the same manner as Example 4 except for the use of the hydroxide. This lithium-containing composite oxide had a BET specific surface area of 0.20 m²/g and a tap density of 2.78 g/cm³. In the lithium-containing composite oxide powder, the ratio of the primary particles with a particle size of 1 μm or less to the total volume of the primary particles, which was measured in the same manner as Example 1, was 8 vol %.

Moreover, a positive electrode and a lithium secondary battery were produced in the same manner as Example 1 except for the use of the above lithium-containing composite oxide. The density of a positive electrode mixture layer of the positive electrode used in the lithium secondary battery was 3.54 g/cm³.

### Example 6

A coprecipitation compound was synthesized in the same manner as Example 1 except for the use of a mixed aqueous solution containing a nickel sulfate, a manganese sulfate, and a magnesium sulfate in their respective concentrations of 3.87 mol/dm³, 0.21 mol/dm³, and 0.13 mol/dm³. Then, a hydroxide containing Ni, Mn, and Mg at a molar ratio of 92:5:3 was obtained in the same manner as Example 1 except for the use of the coprecipitation compound. A lithium-containing composite oxide was synthesized in the same manner as Example 1 except that 0.196 mol of the hydroxide and 0.190 mol of LiOH.H₂O were used. This lithium-containing composite oxide had a BET specific surface area of 0.22 m²/g and a tap density of 2.5 g/cm³. In the lithium-containing composite oxide powder, the ratio of the primary particles with a particle size of 1 μm or less to the total volume of the primary particles, which was measured in the same manner as Example 1, was 12 vol %. Moreover, a positive electrode and a lithium secondary battery were produced in the same manner as Example 1 except for the use of the above lithium-containing composite oxide.

### Example 7

A hydroxide containing Ni, Co, Mn, and Mg at a molar ratio of 90:5:3:2 was synthesized in the same manner as Example 4 except that the concentrations of the material compounds in the mixed aqueous solution used for synthesis of the coprecipitation compound were changed. A lithium-containing composite oxide was synthesized in the same manner as Example 4 except for the use of the hydroxide. This lithium-containing composite oxide had a BET specific surface area of 0.20 m²/g and a tap density of 2.75 g/cm³. In the lithium-containing composite oxide powder, the ratio of the primary particles with a particle size of 1 μm or less to the total volume of the primary particles, which was measured in the same manner as Example 1, was 8 vol %. Moreover, a positive electrode and a lithium secondary battery were produced in the same manner as Example 1 except for the use of the above lithium-containing composite oxide.

### Example 8

A hydroxide containing Ni, Co, Mn, and Mg at a molar ratio of 90:5:3:2 was synthesized in the same manner as Example 5. Then, 99.86 parts by mass (0.196 mol) of the hydroxide, 0.14 parts by mass of a ZrO₂ powder, and 0.204 mol of LiOH.H₂O were dry blended. A lithium-containing composite oxide including Zr was synthesized in the same manner as Example 1. The content of Zr in the lithium-containing composite oxide was 0.10 mass %. Moreover, a positive electrode and a lithium secondary battery were produced in the same manner as Example 1 except for the use of the above lithium-containing composite oxide.

### Example 9

A lithium-containing composite oxide including Ti was synthesized in the same manner as Example 8 except that a TiO₂ powder was used instead of the ZrO₂ powder, and the ratios of the hydroxide containing Ni, Co, Mn, and Mg at a molar ratio of 90:5:3:2 and the TiO₂ powder were 99.91 parts by mass and 0.09 parts by mass, respectively. The content of Ti in the lithium-containing composite oxide was 0.05 mass %. Moreover, a positive electrode and a lithium secondary battery were produced in the same manner as Example 1 except for the use of the above lithium-containing composite oxide.

### Example 10

In Example 8, instead of dry blending the ZrO₂ powder with the hydroxide containing Ni, Co, Mn, and Mg at a molar ratio of 90:5:3:2 and the lithium hydroxide, the ZrO₂ powder was added to a reaction solution after the hydroxide was precipitated, and then stirred to synthesize a composite material in which the surface of the hydroxide was coated with ZrO₂. The ratios of the hydroxide and the ZrO₂ powder were 99.86 parts by mass and 0.14 parts by mass, respectively. A lithium-containing composite oxide including Zr was synthesized in the same manner as Example 8 except that 0.204 mol of LiOH.H₂O relative to 0.196 mol of the hydroxide in the composite material was mixed with the composite material, and the resultant mixture was fired. The content of Zr in the lithium-containing composite oxide was 0.10 mass %. Moreover, a positive electrode and a lithium secondary battery were produced in the same manner as Example 1 except for the use of the above lithium-containing composite oxide.

### Example 11

A lithium-containing composite oxide including Ti was synthesized in the same manner as Example 10 except that a TiO₂ powder was used instead of the ZrO₂ powder, and the ratios of the hydroxide containing Ni, Co, Mn, and Mg at a molar ratio of 90:5:3:2 and the TiO₂ powder were 99.91 parts by mass and 0.09 parts by mass, respectively. The content of Ti in the lithium-containing composite oxide was 0.05 mass %. Moreover, a positive electrode and a lithium secondary battery were produced in the same manner as Example 1 except for the use of the above lithium-containing composite oxide.

### Example 12

99.86 parts by mass of the lithium-containing composite oxide synthesized in Example 5 and 0.14 parts by mass of the ZrO₂ powder were dry blended, and the resultant mixture was fired at 700° C. for 12 hours in an oxygen atmosphere, thus synthesizing a lithium-containing composite oxide whose surface was coated with the Zr oxide. The ratio of Zr to all particles of the lithium-containing composite oxide was 0.10 mass %. Moreover, a positive electrode and a lithium secondary battery were produced in the same manner as Example 1 except for the use of the above lithium-containing composite oxide.

### Example 13

A lithium-containing composite oxide whose surface was coated with a Ti oxide was synthesized in the same manner as Example 12 except that 0.09 parts by mass of a TiO₂ powder was used instead of 0.14 parts by mass of the ZrO₂ powder. The ratio of Ti to all particles of the lithium-containing composite oxide was 0.05 mass %. Moreover, a positive electrode and a lithium secondary battery were produced in the same manner as Example 1 except for the use of the above lithium-containing composite oxide.

### Example 14

90 parts by mass of the lithium-containing composite oxide (number average particle size: 20 μm) synthesized in Example 5 and 10 parts by mass of Li_{1.02}Mn_{1.95}Al_{0.02}Mg_{0.02}Ti_{0.01}O₄ (number average particle size: 5 μm) were dry blended, and then 10 parts by mass of a NMP solution containing PVDF (binder) in a concentration of 10 mass % was added to the mixture, so that composite particles were provided.

Moreover, a positive electrode and a lithium secondary battery were produced in the same manner as Example 1 except that the composite particles were used instead of the lithium-containing composite oxide.

### Example 15

Composite particles were prepared in the same manner as Example 14 except that LiCu_{0.975}Al_{0.01}Mg_{0.01}Ti_{0.005}O₂ (number average particle size: 6 μm) was used instead of Li_{1.02}Mn_{1.95}Al_{0.02}Mg_{0.02}Ti_{0.01}O₄. Moreover, a positive electrode and a lithium secondary battery were produced in the same manner as Example 14 except for the use of the composite particles.

### Example 16

Composite particles were prepared in the same manner as Example 14 except that LiMn_{0.315}Cu_{0.33}Ni_{0.33}Al_{0.01}Mg_{0.01}Ti_{0.005}O₂ (number average particle size: 6 μm) was used instead of Li_{1.02}Mn_{1.95}Al_{0.02}Mg_{0.02}Ti_{0.01}O₄. Moreover, a positive electrode and a lithium secondary battery were produced in the same manner as Example 14 except for the use of the composite particles.

### Comparative Example 1

A coprecipitation compound was synthesized in the same manner as Example 1 except for the use of a mixed aqueous solution containing a nickel sulfate and a cobalt sulfate in their respective concentrations of 3.79 mol/dm³ and 0.42 mol/dm³. Then, a hydroxide containing Ni and Co at a molar ratio of 90:10 was obtained in the same manner as Example 1 except for the use of the coprecipitation compound. A lithium-containing composite oxide was synthesized in the same manner as Example 1 except that 0.196 mol of the hydroxide and 0.204 mol of LiOH.H₂O were used. Moreover, a positive electrode and a lithium secondary battery were produced in the same manner as Example 1 except for the use of the above lithium-containing composite oxide.

### Comparative Example 2

A coprecipitation compound was synthesized in the same manner as Example 1 except for the use of a mixed aqueous solution containing a nickel sulfate, a cobalt sulfate, and a magnesium sulfate in their respective concentrations of 3.79 mol/dm³, 0.38 mol/dm³, and 0.04 mol/dm³. Then, a hydroxide containing Ni, Co, and Mg at a molar ratio of 90:9:1 was obtained in the same manner as Example 1 except for the use of the coprecipitation compound. A lithium-containing composite oxide was synthesized in the same manner as Example 1 except that 0.196 mol of the hydroxide and 0.204 mol of LiOH.H₂O were used. Moreover, a positive electrode and a lithium secondary battery were produced in the same manner as Example 1 except for the use of the above lithium-containing composite oxide.

### Comparative Example 3

A coprecipitation compound was synthesized in the same manner as Example 1 except for the use of a mixed aqueous solution containing a nickel sulfate, a cobalt sulfate, and a manganese sulfate in their respective concentrations of 3.79 mol/dm³, 0.21 mol/dm³, and 0.21 mol/dm³. Then, a hydroxide containing Ni, Co, and Mn at a molar ratio of 90:5:5 was obtained in the same manner as Example 1 except for the use of the coprecipitation compound. A lithium-containing composite oxide was synthesized in the same manner as Example 1 except that 0.196 mol of the hydroxide and 0.204 mol of LiOH.H₂O were used. Moreover, a positive electrode and a lithium secondary battery were produced in the same manner as Example 1 except for the use of the above lithium-containing composite oxide.

### Comparative Example 4

A coprecipitation compound was synthesized in the same manner as Example 1 except for the use of a mixed aqueous solution containing a nickel sulfate, a cobalt sulfate, and aluminum sulfate in their respective concentrations of 3.79 mol/dm³, 0.21 mol/dm³, and 0.21 mol/dm³. Then, a hydroxide containing Ni, Co, and Al at a molar ratio of 90:5:5 was obtained in the same manner as Example 1 except for the use of the coprecipitation compound. A lithium-containing composite oxide was synthesized in the same manner as Example 1 except that 0.196 mol of the hydroxide and 0.204 mol of LiOH.H₂O were used. Moreover, a positive electrode and a lithium secondary battery were produced in the same manner as Example 1 except for the use of the above lithium-containing composite oxide.

### Comparative Example 5

A positive electrode and a lithium secondary battery were produced in the same manner as Example 1 except that commercially available Li_{1.02}Ni_{0.80}Co_{0.15}Al_{0.05}O₂ was used as the lithium-containing composite oxide.

### Comparative Example 6

A hydroxide containing Ni, Co, and Mn at a molar ratio of 60:20:20 was synthesized in the same manner as Comparative Example 3 except that the concentrations of the material compounds in the mixed aqueous solution used for synthesis of the coprecipitation compound were changed. A lithium-containing composite oxide was synthesized in the same manner as Comparative Example 3 except for the use of the hydroxide. Moreover, a positive electrode and a lithium secondary battery were produced in the same manner as Example 1 except for the use of the above lithium-containing composite oxide.

### Comparative Example 7

A hydroxide containing Ni, Mn, and Mg at a molar ratio of 70:20:10 was synthesized in the same manner as Example 1 except that the concentrations of the material compounds in the mixed aqueous solution used for synthesis of the coprecipitation compound were changed. A lithium-containing composite oxide was synthesized in the same manner as Example 1 except for the use of the hydroxide. Moreover, a positive electrode and a lithium secondary battery were produced in the same manner as Example 1 except for the use of the above lithium-containing composite oxide.

### Comparative Example 8

A hydroxide containing Ni, Mn, and Mg at a molar ratio of 94:3:3 was synthesized in the same manner as Example 1 except that the concentrations of the material compounds in the mixed aqueous solution used for synthesis of the coprecipitation compound were changed. Then, 0.196 mol of the hydroxide and 0.204 mol of LiOH.H₂O were dispersed in ethanol to form a slurry. The slurry was mixed in a planetary ball mill for 40 minutes and dried at room temperature, so that a mixture was obtained. Next, the mixture was put in an alumina crucible, heated to a temperature of 600° C. in a dry air flow of 2 dm³/min, and held at that temperature for 2 hours for preheating. Further, the temperature was raised to 1000° C., and the mixture was fired for 12 hours in an ambient atmosphere, thus synthesizing a lithium-containing composite oxide. Moreover, a positive electrode and a lithium secondary battery were produced in the same manner as Example 1 except for the use of the above lithium-containing composite oxide.

### Comparative Example 9

A hydroxide containing Ni, Co, Mn, and Mg at a molar ratio of 92:6:1:1 was synthesized in the same manner as Example 4 except that the concentrations of the material compounds in the mixed aqueous solution used for synthesis of the coprecipitation compound were changed. Then, 0.196 mol of the hydroxide and 0.204 mol of LiOH.H₂O were dispersed in ethanol to form a slurry. The slurry was mixed in a planetary ball mill for 40 minutes and dried at room temperature, so that a mixture was obtained. Next, the mixture was put in an alumina crucible, heated to a temperature of 600° C. in a dry air flow of 2 dm³/min, and held at that temperature for 2 hours for preheating. Further, the temperature was raised to 1000° C., and the mixture was fired for 12 hours in an ambient atmosphere, thus synthesizing a lithium-containing composite oxide. Moreover, a positive electrode and a lithium secondary battery were produced in the same manner as Example 1 except for the use of the above lithium-containing composite oxide.

### Comparative Example 10

A lithium-containing composite oxide was synthesized in the same manner as Comparative Example 1 except that 0.196 mol of the hydroxide containing Ni and Co at a molar ratio of 90:10 and 0.190 mol of LiOH.H₂O were used. Moreover, a positive electrode and a lithium secondary battery were produced in the same manner as Comparative Example 1 except for the use of the above lithium-containing composite oxide.

### Comparative Example 11

A lithium-containing composite oxide was synthesized in the same manner as Comparative Example 3 except that 0.196 mol of the hydroxide containing Ni, Co, and Mn at a molar ratio of 90:5:5 and 0.190 mol of LiOH.H₂O were used. Moreover, a positive electrode and a lithium secondary battery were produced in the same manner as Comparative Example 3 except for the use of the above lithium-containing composite oxide.

Similarly to Example 1, the average valences of the constituent elements Ni, Co, Mn, and Mg and the integrated intensity ratio (I₍₀₀₃₎/I₍₁₀₄₎) in X-ray diffraction were measured for each of the lithium-containing composite oxides used for the positive electrodes in Examples 2 to 13 and Comparative Examples 1 to 11.

Tables 1 and 2 show the compositions of the lithium-containing composite oxides used for the positive electrodes in Examples 1 to 13 and Comparative Examples 1 to 11. Table 3 shows the average valences of the constituent elements Ni, Co, Mn, and Mg and the integrated intensity ratio (I₍₀₀₃₎/I₍₀₀₄₎) in X-ray diffraction for each of the lithium-containing composite oxides used for the positive electrodes in Examples 1 to 13 and Comparative Examples 1 to 11.

TABLE 1

| | Composition of lithium-containing composite oxide | | | | | | | |
|---|---|---|---|---|---|---|---|---|
| | Composition formula | x | a | b | c | d | b − c | (b − c)/c |
| Example 1 | Li_{1.02}Ni_{0.94}Mn_{0.03}Mg_{0.03}O₂ | 0.02 | 94 | 3 | 3 | — | 0 | 0 |
| Example 2 | Li_{1.02}Ni_{0.92}Mn_{0.05}Mg_{0.03}O₂ | 0.02 | 92 | 5 | 3 | — | 2 | 0.67 |
| Example 3 | Li_{1.02}Ni_{0.94}Mn_{0.03}Mg_{0.02}Al_{0.01}O₂ | 0.02 | 94 | 3 | 2 | — | 1 | 0.5 |
| Example 4 | Li_{1.02}Ni_{0.92}Co_{0.06}Mn_{0.01}Mg_{0.01}O₂ | 0.02 | 92 | 1 | 1 | 6 | 0 | 0 |
| Example 5 | Li_{1.02}Ni_{0.90}Co_{0.05}Mn_{0.03}Mg_{0.02}O₂ | 0.02 | 90 | 3 | 2 | 5 | 1 | 0.5 |
| Example 6 | Li_{0.95}Ni_{0.92}Mn_{0.05}Mg_{0.03}O₂ | −0.05 | 92 | 5 | 3 | — | 2 | 0.67 |
| Example 7 | Li_{0.95}Ni_{0.90}Co_{0.05}Mn_{0.03}Mg_{0.02}O₂ | −0.05 | 90 | 3 | 2 | 5 | 1 | 0.5 |
| Example 8 | Li_{1.02}Ni_{0.899}Co_{0.05}Mn_{0.03}Mg_{0.02}Zr_{0.001}O₂ | 0.02 | 90 | 3 | 2 | 5 | 1 | 0.5 |
| Example 9 | Li_{1.01}Ni_{0.899}Co_{0.05}Mn_{0.03}Mg_{0.02}Ti_{0.001}O₂ | 0.01 | 90 | 3 | 2 | 5 | 1 | 0.5 |
| Example 10 | Li_{1.00}Ni_{0.899}Co_{0.05}Mn_{0.03}Mg_{0.02}Zr_{0.001}O₂ | 0 | 90 | 3 | 2 | 5 | 1 | 0.5 |
| Example 11 | Li_{1.00}Ni_{0.899}Co_{0.05}Mn_{0.03}Mg_{0.02}Ti_{0.001}O₂ | 0 | 90 | 3 | 2 | 5 | 1 | 0.5 |
| Example 12 | Li_{1.02}Ni_{0.899}Co_{0.05}Mn_{0.03}Mg_{0.02}Zr_{0.001}O₂ | 0.02 | 90 | 3 | 2 | 5 | 1 | 0.5 |
| Example 13 | Li_{1.01}Ni_{0.899}Co_{0.05}Mn_{0.03}Mg_{0.02}Ti_{0.001}O₂ | 0.01 | 90 | 3 | 2 | 5 | 1 | 0.5 |

TABLE 2

| | Composition of lithium-containing composite oxide | | | | | | | |
|---|---|---|---|---|---|---|---|---|
| | Composition formula | x | a | b | c | d | b − c | (b − c)/c |
| Comparative Example 1 | Li_{1.02}Ni_{0.90}Co_{0.10}O₂ | 0.02 | 90 | — | — | 10 | — | — |
| Comparative Example 2 | Li_{1.02}Ni_{0.90}Co_{0.09}Mg_{0.01}O₂ | 0.02 | 90 | — | 1 | 9 | — | — |
| Comparative Example 3 | Li_{1.02}Ni_{0.90}Co_{0.05}Mn_{0.05}O₂ | 0.02 | 90 | 5 | — | 5 | — | — |
| Comparative Example 4 | Li_{1.02}Ni_{0.90}Co_{0.05}Al_{0.05}O₂ | 0.02 | 90 | — | — | 5 | — | — |
| Comparative Example 5 | Li_{1.02}Ni_{0.80}Co_{0.15}Al_{0.05}O₂ | 0.02 | 80 | — | — | 15 | — | — |
| Comparative Example 6 | Li_{1.02}Ni_{0.60}Co_{0.20}Mn_{0.20}O₂ | 0.02 | 60 | 20 | — | 20 | — | — |
| Comparative Example 7 | Li_{1.02}Ni_{0.70}Mn_{0.20}Mg_{0.10}O₂ | 0.02 | 70 | 20 | 10 | — | 10 | 1 |
| Comparative Example 8 | Li_{1.02}Ni_{0.94}Mn_{0.03}Mg_{0.03}O₂ | 0.02 | 94 | 3 | 3 | — | 0 | 0 |
| Comparative Example 9 | Li_{1.02}Ni_{0.92}Co_{0.06}Mn_{0.01}Mg_{0.01}O₂ | 0.02 | 92 | 1 | 1 | 6 | 0 | 0 |
| Comparative Example 10 | Li_{0.95}Ni_{0.90}Co_{0.10}O₂ | −0.05 | 90 | — | — | 10 | — | — |
| Comparative Example 11 | Li_{0.95}Ni_{0.90}Co_{0.05}Mn_{0.05}O₂ | −0.05 | 90 | 5 | — | 5 | — | — |

TABLE 3

| | Average valence of constituent element | | | | Integrated intensity |
|---|---|---|---|---|---|
| | Ni | Co | Mn | Mg | ratio I₍₀₀₃₎/I₍₁₀₄₎ |
| Example 1 | 3.02 | — | 4.02 | 2.01 | 1.24 |
| Example 2 | 2.98 | — | 4.02 | 2.01 | 1.22 |
| Example 3 | 2.99 | — | 4.02 | 2.01 | 1.22 |
| Example 4 | 3.02 | 3.02 | 4.02 | 2.01 | 1.22 |
| Example 5 | 2.99 | 3.02 | 4.02 | 2.01 | 1.22 |
| Example 6 | 2.85 | — | 3.98 | 2.01 | 1.22 |
| Example 7 | 2.88 | 3.02 | 3.98 | 2.01 | 1.22 |
| Example 8 | 3.02 | 3.02 | 4.02 | 2.01 | 1.22 |
| Example 9 | 3.02 | 3.02 | 3.98 | 2.01 | 1.22 |
| Example 10 | 3.02 | 3.02 | 4.02 | 2.01 | 1.22 |
| Example 11 | 3.02 | 3.02 | 3.98 | 2.01 | 1.22 |
| Example 12 | 3.02 | 3.02 | 4.02 | 2.01 | 1.22 |
| Example 13 | 3.02 | 3.02 | 4.02 | 2.01 | 1.22 |
| Comparative Example 1 | 2.95 | 3.02 | — | — | 1.26 |
| Comparative Example 2 | 2.98 | 3.02 | — | 2.01 | 1.22 |
| Comparative Example 3 | 2.94 | 3.02 | 4.02 | — | 1.22 |
| Comparative Example 4 | 2.95 | 3.02 | — | — | 1.15 |
| Comparative Example 5 | 3.02 | 3.02 | — | — | 1.28 |
| Comparative Example 6 | 2.68 | 3.02 | 4.02 | — | 1.25 |
| Comparative Example 7 | 2.78 | — | 4.02 | 2.01 | 1.05 |
| Comparative Example 8 | 2.35 | — | 3.32 | 2.01 | 0.82 |
| Comparative Example 9 | 2.40 | 2.64 | 3.44 | 2.01 | 0.82 |
| Comparative Example 10 | 2.80 | 3.02 | — | — | 1.05 |
| Comparative Example 11 | 2.84 | 3.02 | 4.02 | — | 1.10 |

Each of the following evaluations was performed on the lithium secondary batteries in Examples 1 to 16 and Comparative Examples 1 to 11. Table 4 shows the results.

<Standard Capacity>

The batteries in Examples 1 to 16 and Comparative Examples 1 to 11 were stored at 60° C. for 7 hours. Thereafter, charge and discharge cycles, in which each of the batteries was charged at 200 mA for 5 hours and discharged at 200 mA until the battery voltage was reduced to 2.5 V, were repeated at 20° C. until the discharged capacity was constant. Next, a constant-current and constant-voltage charge (constant current: 500 mA, constant voltage: 4.2 V, and total charge time: 3 hours) was performed and brought to a standstill for 1 hour. Subsequently, each of the batteries was discharged at 200 mA until the battery voltage reached 2.5 V, and a standard capacity was determined. In calculating the standard capacity, 100 batteries for each example were measured, and the average of the standard capacities was taken as the standard capacity in each of Examples and Comparative Examples.

Moreover, the standard capacity was divided by the mass of the lithium-containing composite oxide included in the positive electrode, yielding a positive electrode discharged capacity.

<Charge-Discharge Cycle Characteristics>

For the batteries in Examples 1 to 16 and Comparative Examples 1 to 11, charge and discharge cycles were repeated, in which a constant-current and constant-voltage charge was performed under the same conditions as the measurement of the standard capacity and brought to a standstill for 1 minute, and then each of the batteries was discharged at 200 mA until the battery voltage reached 2.5 V. The number of cycles was counted until the discharged capacity was reduced to 80% of the discharged capacity in the first cycle. Thus, the charge cycle characteristics of each of the batteries were evaluated. In calculating the number of cycles for the charge-discharge cycle characteristics, 10 batteries for each example were measured, and the average of the numbers of cycles was taken as the number of cycles in each of Examples and Comparative Examples.

<Safety Evaluation>

A constant-current and constant-voltage charge (constant current: 600 mA, constant voltage: 4.25 V, and total charge time: 3 hours) was performed on the batteries in Examples 1 to 16 and Comparative Examples 1 to 11. Thereafter, each of the batteries was placed in a thermostatic bath and allowed to stand for 2 hours, and then the temperature was raised from 30° C. to 170° C. at a rate of 5° C. per minute. Subsequently, each of the batteries was allowed to stand for 3 hours at 170° C., and the surface temperature of the battery was measured. In this case, the battery was identified as A when the maximum temperature attained was 180° C. or less and was identified as B when the maximum temperature attained was more than 180° C.

TABLE 4

| | | Positive | | |
|---|---|---|---|---|
| | | electrode | | |
| | Standard | discharged | Number of | |
| | capacity | capacity | cycles | |
| | (mAh) | (mAh/g) | (times) | Safety |
| Example 1 | 911 | 205 | 502 | A |
| Example 2 | 898 | 202 | 508 | A |
| Example 3 | 894 | 202 | 514 | A |
| Example 4 | 914 | 205 | 526 | A |
| Example 5 | 894 | 200 | 532 | A |
| Example 6 | 882 | 198 | 505 | A |
| Example 7 | 875 | 196 | 530 | A |
| Example 8 | 870 | 192 | 656 | A |
| Example 9 | 875 | 193 | 604 | A |
| Example 10 | 884 | 195 | 664 | A |
| Example 11 | 890 | 198 | 602 | A |
| Example 12 | 888 | 197 | 692 | A |
| Example 13 | 874 | 198 | 622 | A |
| Example 14 | 867 | 196 | 526 | A |
| Example 15 | 849 | 192 | 532 | A |
| Example 16 | 875 | 198 | 521 | A |
| Comparative Example 1 | 931 | 210 | 150 | B |
| Comparative Example 2 | 914 | 208 | 224 | B |
| Comparative Example 3 | 826 | 195 | 272 | A |
| Comparative Example 4 | 792 | 178 | 464 | A |
| Comparative Example 5 | 805 | 180 | 473 | A |
| Comparative Example 6 | 770 | 171 | 426 | A |
| Comparative Example 7 | 544 | 125 | 218 | A |
| Comparative Example 8 | 423 | 96 | 88 | A |
| Comparative Example 9 | 444 | 102 | 94 | A |
| Comparative Example 10 | 840 | 190 | 120 | B |
| Comparative Example 11 | 780 | 180 | 220 | B |

The lithium secondary batteries in Examples 1 to 16 included the lithium-containing composite oxide having proper composition and average valences of Ni, Mn, and Mg (and further Co), and had the positive electrode with a large capacity and excellent thermal stability. Therefore, as can be seen from Table 4, the lithium secondary batteries in Examples 1 to 16 had a large standard capacity, excellent safety, and good charge-discharge cycle characteristics.

In particular, the use of the lithium-containing composite oxides of Examples 6 and 7, in which x of the general composition formula (1) was less than 0 and the Li ratio was smaller than the stoichiometric ratio, suppressed gelation of the paste containing the positive electrode mixture and improved the coating stability, compared to the use of the lithium-containing composite oxides of Examples 1 to 5. In Examples 6 and 7, since the stable crystal structure was maintained in spite of x<0, the lithium secondary batteries had excellent characteristics comparable to those of the lithium secondary batteries using the lithium-containing composite oxides with x≧0 in Examples 1 to 5. Examples 8 to 13, each of which used the lithium-containing composite oxide including Zr or Ti in the positive electrode, showed excellent cycle characteristics. This may be because the surface activity of the lithium-containing composite oxide can be suppressed without impairing its electrochemical properties.

In contrast, the lithium secondary batteries in Comparative Examples 1 to 7, 10, and 11, each of which included the positive electrode including the lithium-containing composite oxide having the composition that did not satisfy the general composition formula (1), had low charge-discharge cycle characteristics, poor safety, and thus a small standard capacity. Moreover, the lithium secondary batteries in Comparative Examples 8 and 9, each of which included the positive electrode including the lithium-containing composite oxide with the average valences of Ni and Mn being inappropriate, had a small standard capacity and low charge-discharge cycle characteristics, since the reversibility of the crystal structure of the lithium-containing composite oxide was low.

Further, the following evaluation was performed on the lithium secondary batteries in Examples 5 and 14 to 16. Table 5 shows the results.

<DOD 10% Cycle Characteristics>

For the batteries in Examples 5 and 14 to 16, charge and discharge cycles were repeated, in which a constant-current and constant-voltage charge was performed under the same conditions as the measurement of the standard capacity and brought to a standstill for 1 minute, and then each of the batteries was discharged at 1000 mA for 6 minutes. In other words, the charge and discharge cycles of the batteries were repeated under the discharge conditions (discharged electrical quantity: 100 mAh) that the depth of discharge (DOD) was about 10%, and the number of cycles was measured until the internal resistance of each of the batteries was increased to 1.5 times of the initial value. In this case, 10 batteries for each example were tested, and the average of the numbers of cycles was taken as the number of cycles, as shown in Table 5. The DOD 10% cycle characteristics of each of the batteries were evaluated based on this value.

TABLE 5

| | Number of cycles (times) |
|---|---|
| Example 5 | 1250 |
| Example 14 | 1450 |
| Example 15 | 1450 |
| Example 16 | 1400 |

As can be seen from Table 5, the batteries in Examples 14 to 16, each of which included the lithium-containing composite oxide of the present invention and the other active materials having a higher operating voltage than the lithium-containing composite oxide, had excellent cycle characteristics when charged and discharged in the range in which the depth of discharge was shallow.

The stability of the crystal structure of the lithium-containing composite oxide of the present invention is lower in the range in which the depth of discharge is about 10% compared to the depth of discharge greater than this. Therefore, if the charge and discharge cycles are repeated in the range in which the depth of discharge is shallow, the excellent characteristics of the lithium-containing composite oxide are not likely to be provided. On the other hand, when the active material having a high operating voltage is used with the lithium-containing composite oxide, the active material having a high operating voltage mainly contributes to discharge in the range in which the depth of discharge is about 10%. Thus, it is considered that the polarization of the electrode due to instability of the crystal structure of the lithium-containing composite oxide of the present invention can be reduced.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes that come within the meaning and range of equivalency of the claims are intended to be embraced therein.

### INDUSTRIAL APPLICABILITY

As described above, the present invention can provide an electrode for an electrochemical device with a high capacity and high stability, and an electrochemical device that includes the electrode for an electrochemical device and has a high capacity, excellent charge-discharge cycle characteristics, and excellent safety. The electrochemical device of the present invention is applicable not only to power sources for various electronic equipment, e.g., portable electronic equipment such as a portable telephone and a notebook personal computer, but also to safety-oriented power tools, vehicles, motorcycles, and stationary energy storage.

### DESCRIPTION OF REFERENCE NUMERALS

1 Positive electrode
2 Negative electrode
3 Separator

1. An electrode for an electrochemical device comprising:
an electrode mixture layer that includes a lithium-containing composite oxide expressed by the following general composition formula (1) as an active material:
Li₁₊ₓMO₂ (1)
where x satisfies −0.3≦x≦0.3 and M represents an element group including Ni, Mn, and Mg,
wherein 70≦a≦97, 0.5<b<30, 0.5<c<30, −10<b−c<10, and −8≦(b−c)/c≦8 are established, where a, b, and c represent ratios of a number of elements of Ni, Mn, and Mg in the element group M to a total number of elements in the element group M, respectively, in units of mol %, and
wherein the Ni has an average valence of 2.5 to 3.2, the Mn has an average valence of 3.5 to 4.2, and the Mg has an average valence of 1.8 to 2.2.

2. The electrode for an electrochemical device according to claim 1, wherein assuming that an integrated intensity of a diffraction line in a (003) plane and an integrated intensity of a diffraction line in a (104) plane in an X-ray diffraction diagram of the lithium-containing composite oxide are represented by I₍₀₀₃₎ and I₍₁₀₄₎, respectively, a I₍₀₀₃₎/I₍₁₀₄₎ ratio is 1.2 or more.

3. The electrode for an electrochemical device according to claim 1, wherein assuming that x<0 in the general composition formula (1), and an integrated intensity of a diffraction line in a (003) plane and an integrated intensity of a diffraction line in a (104) plane in an X-ray diffraction diagram of the lithium-containing composite oxide are represented by I₍₀₀₃₎ and I₍₁₀₄₎, respectively, a I₍₀₀₃₎/I₍₁₀₄₎ ratio is 1.2 or more.

4. The electrode for an electrochemical device according to claim 1, wherein the element group M of the general composition formula (1) further includes Co, and
0<d≦30 is established, where d represents a ratio of a number of elements of Co in the element group M to the total number of elements in the element group M, in units of mol %.

5. The electrode for an electrochemical device according to claim 1, wherein the element group M of the general composition formula (1) further includes Co, and
0<d<30 is established, where d represents a ratio of a number of elements of Co in the element group M to the total number of elements in the element group M, in units of mol %, and
wherein the Co has an average valence of 2.5 to 3.2.

6. The electrode for an electrochemical device according to claim 1, wherein the element group M of the general composition formula (1) further includes Zr.

7. The electrode for an electrochemical device according to claim 1, wherein the element group M of the general composition formula (1) further includes Ti.

8. The electrode for an electrochemical device according to claim 1, wherein the element group M of the general composition formula (1) further includes Zr, and
a surface of the lithium-containing composite oxide is coated with a Zr compound.

9. The electrode for an electrochemical device according to claim 1, wherein the element group M of the general composition formula (1) further includes Ti, and
a surface of the lithium-containing composite oxide is coated with a Ti compound.

10. The electrode for an electrochemical device according to claim 1, wherein particles of the lithium-containing composite oxide mainly include secondary particles formed by agglomeration of primary particles,
a volume ratio of the primary particles with a particle size of 1 μm or less to a total volume of the primary particles is 30 vol % or less, and
a BET specific surface area of the lithium-containing composite oxide is 0.3 m²/g or less.

11. The electrode for an electrochemical device according to claim 1, wherein a tap density of the lithium-containing composite oxide is 2.4 g/cm³ or more.

12. The electrode for an electrochemical device according to claim 1, wherein a density of the electrode mixture layer is 3.1 g/cm³ or more.

13. The electrode for an electrochemical device according to claim 1, wherein the electrode mixture layer includes at least one selected from the group consisting of polyvinylidene fluoride, polytetrafluoroethylene, and polyhexafluoropropylene as a binder.

14. The electrode for an electrochemical device according to claim 1, wherein the electrode mixture layer includes at least one selected from the group consisting of graphite and carbon black as a conductive assistant.

15. An electrochemical device comprising:
a positive electrode;
a negative electrode; and
a non-aqueous electrolyte,
wherein the positive electrode is the electrode for an electrochemical device according to any one of claims 1 to 14.
